(19) United States
(12) Patent Application Publication
(10) Pub. No.: US 2003/0193600 A1
(43) Pub. Date: Oct. 16, 2003

(54) Image capturing apparatus

(75) Inventors: Masahiro Kitamura, Osaka-shi (JP); Noriyuki Okisu, Osakasayama-shi (JP); Keiji Tamai, Suita-shi (JP); Motohiro Nakanishi, Kobe-shi (JP); Toshihiro Hamamura, Osaka-shi (JP); Shinichi Fujii, Osaka-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD

(21) Appl. No.: 10/392,407

(22) Filed: Mar. 19, 2003

(30) Foreign Application Priority Data
Mar. 28, 2002 (JP) P2002-090735
May 30, 2002 (JP) P2002-156987

(51) Int. Cl. H04N 5/222

(52) U.S. Cl. 348/333.01

(57) ABSTRACT

A digital camera obtains image data of a subject by a CCD. The CCD has, as image data output modes, a “normal mode” of outputting all of pixels of the image data at 60 fps and an “area-limited mode” of outputting an area including a limited focus area in the image data at 180 fps. The output mode of the CCD is set to the “normal mode” in a live-view operation. At the time of an auto-focus control, the output mode is switched at the intervals of 1/60 second between the “area-limited mode” and the “normal mode”. While the output mode of the CCD is set to the “area-limited mode”, the state of a display screen of a liquid crystal monitor is held. Consequently, while performing auto-focus promptly, a subject image can be appropriately displayed on the display screen of the liquid crystal monitor.

This application is based on application Nos. 2002-090735 and 2002-156987 filed in Japan, the contents of which are hereby incorporated by reference.

### BACKGROUND OF THE INVENTION

1. Field of the Invention

The present invention relates to a focus control technique of an image capturing apparatus.

2. Description of the Background Art

Conventionally, in an image capturing apparatus for obtaining image data by using an image capturing device such as a CCD like a digital still camera (hereinafter, simply referred to as a “digital camera”) or a video camera, a technique called a contrast method (or hill climbing method) is applied to an auto-focus control. The contrast method is a method of obtaining, as an evaluation value, contrast of image data obtained at each of driving stages while driving a focusing lens, to determine a position of the lens at which the evaluation value is the highest as a focus position.

In an image capturing apparatus having a display such as a liquid crystal monitor, live-view display is performed by obtaining image data every predetermined time in an image capturing standby state and displaying a subject image on the display on the basis of the obtained image data. By such live-view display, a user can perform framing while recognizing a subject image having no parallax.

In recent years, improvement in operation speed of auto-focus control is demanded in the image capturing apparatus. Generally, an evaluation value is obtained from a predetermined focus area as a limited area where an image of a main subject is very likely to exist in image data, so that it is sufficient to obtain image data including the predetermined focus area in order to perform the auto-focus control. In the case where an area of image data outputted from an image capturing device is limited, image data can be obtained at a relatively high frame rate. Consequently, by outputting a limited image data including at least a focus area, improvement in speed of the auto-focus control operation is expected.

However, in the case of outputting a limited image data from the image capturing device, a problem occurs such that the whole image of the subject cannot be displayed on a display such as a liquid crystal monitor.

Conventionally, in order to obtain image data at a relatively high frame rate, image data is read while being compressed by skipping at a predetermined ratio and the compressed image data is outputted from image capturing device. When the ratio of skipping at the time of reading image data is increased, the frame rate can be increased, and further improvement in speed of the auto-focus control can be expected.

However, at the time of auto-focus control, in order to also display a live-view on the display, the resolution of image data outputted from the image capturing device has to be equal to or higher than resolution of the display. Specifically, the amount of image data outputted from the image capturing device is constrained to the amount of data necessary to display a subject image on the display. Consequently, the frame rate cannot be increased and a problem such that the speed of the auto-focus control cannot be further increased occurs.

### SUMMARY OF THE INVENTION

The present invention is directed to an image capturing apparatus for obtaining an image of a subject.

According to the present invention, an image capturing apparatus comprises: an image capturing part for obtaining an image of a subject via an optical system, the image capturing part having a first output mode of outputting first image data expressing a whole area of the image and a second output mode of outputting second image data including at least a focusing area of the image at higher speed as compared with the first output mode; a focus controller for performing a focus control of the optical system by referring to the focusing area; a display for displaying the image of the subject on a display screen on the basis of the first image data; an image capturing controller for enabling the second output mode in performing the focus control; and a display controller for holding a state of the image of the subject on the display screen in the second output mode.

Since the state of the image of the subject on the display screen is held in the second output mode, while performing the focus control promptly, the image of the subject can be displayed on the display.

According to an aspect of the present invention, the image capturing controller alternately enables the first output mode and the second output mode at predetermined intervals in performing the focus control.

Since the first image data expressing the whole area of an image is outputted at the predetermined intervals, the image of the subject on the display screen can be updated at the predetermined intervals, at the time of performing the focus control.

According to another aspect of the present invention, an image capturing apparatus comprises: an image capturing part for obtaining an image of a subject via an optical system; a focus controller for performing a focus control of the optical system; and an image display. The image capturing part has a first output mode of outputting first image data which is sufficient for both performing the focus control and displaying the image of the subject, and a second output mode of outputting second image data which is sufficient for performing the focus control but is insufficient for displaying the image of the subject. The image capturing apparatus further comprises a screen image generator for generating a screen image of the subject on the basis of the second image data, and the screen image is displayed on the image display in the second output mode.

Since the screen image is generated on the basis of the second image data when the image capturing part outputs the second image data which is insufficient for displaying an image of a subject, an image of a subject can be displayed on the image display.

Therefore, an object of the present invention is to provide an image capturing apparatus capable of appropriately displaying an image of a subject on a display while promptly performing a focus control.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a digital camera as an image capturing apparatus in preferred embodiments;

FIG. 2 is a diagram showing a configuration of a rear side of the digital camera;

FIG. 3 is a block diagram showing main internal components of a digital camera of a first preferred embodiment;

FIG. 4 is a diagram showing image data obtained by a CCD and a normal image;

FIG. 5 is a diagram showing image data obtained by the CCD and an area-limited image;

FIG. 6 is a diagram showing an example of the relation between a lens position and a focus evaluation value;

FIG. 7 is a diagram schematically showing operations in an image capturing mode of the digital camera of the first preferred embodiment;

FIGS. 8 to 10 are diagrams showing the flow of auto-focus control operation in the first preferred embodiment;

FIG. 11 is a time chart showing processes of the auto-focus control in the first preferred embodiment;

FIG. 12 is a diagram showing the flow of auto-focus control operation in a second preferred embodiment;

FIG. 13 is a time chart showing processes of the auto-focus control in the second preferred embodiment;

FIG. 14 is a block diagram showing main internal components of a digital camera of a third preferred embodiment;

FIG. 15 is a diagram showing an example of a pixel array of a photosensitive part of a CCD;

FIG. 16 is a diagram showing image data outputted from the CCD of the third preferred embodiment;

FIG. 17 is a diagram for describing a read line of obtained image data;

FIG. 18 is a diagram schematically showing the operation in an image capturing mode in the digital camera of the third preferred embodiment;

FIG. 19 is a diagram for describing a method of generating a live-view image from a first compressed image;

FIG. 20 is a diagram showing the flow of a process of selecting either a normal control or a high-speed control;

FIG. 21 is a diagram showing an auto-focus control operation in the normal control;

FIG. 22 is a diagram showing an auto-focus control operation in a high-speed control of the third preferred embodiment;

FIG. 23 is a diagram for describing a method of generating a live-view image from a second compressed image;

FIG. 24 is a diagram showing image data outputted from a CCD of a fourth preferred embodiment;

FIG. 25 is a diagram showing an auto-focus control operation in high-speed control of the fourth preferred embodiment;

FIG. 26 is a diagram for describing a method of generating a live-view image on the basis of the first compressed image and the area-limited image;

FIG. 27 is a diagram showing an example of a live-view image generated in the fourth preferred embodiment; and

FIG. 28 is a diagram showing an auto-focus control operation in high-speed control of a fifth preferred embodiment.

### DESCRIPTION OF THE PREFERRED EMBODIMENTS

Hereinafter, embodiments of the present invention will be described in detail with reference to the drawings. In the following, a digital camera will be described as an example of an image capturing apparatus.

1. First Preferred Embodiment

1-1. Configuration of Digital Camera

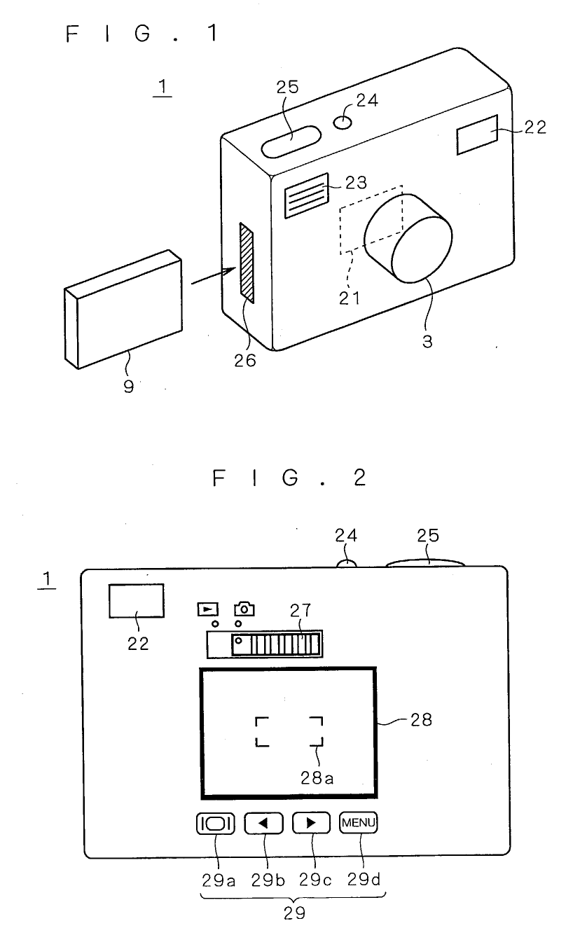

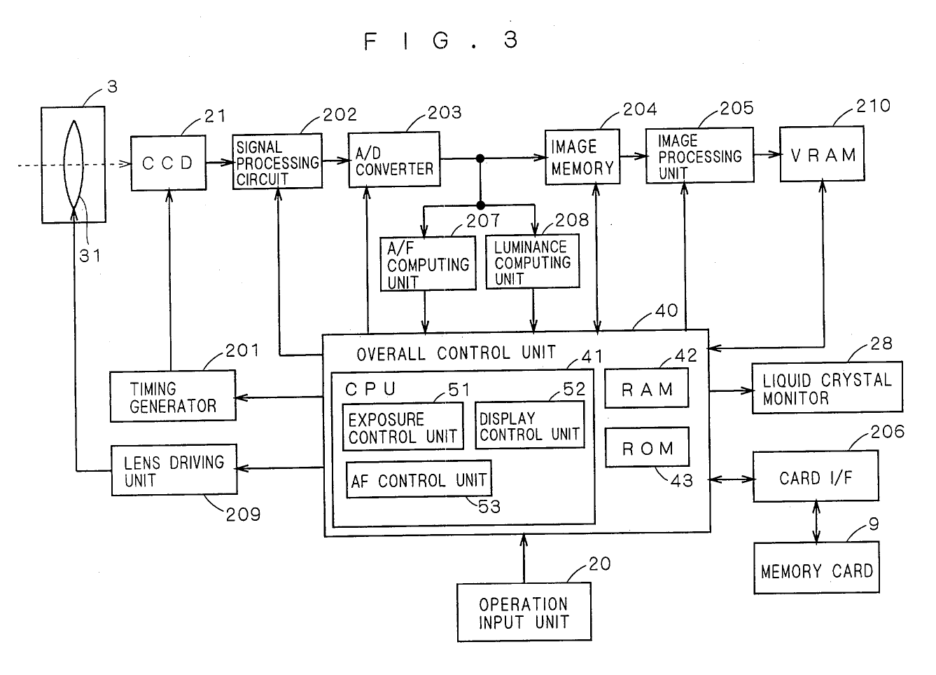

First, the configuration of a digital camera 1 will be described. FIG. 1 is a perspective view showing the digital camera 1. FIG. 2 is a diagram showing the configuration on a rear face side of the digital camera 1.

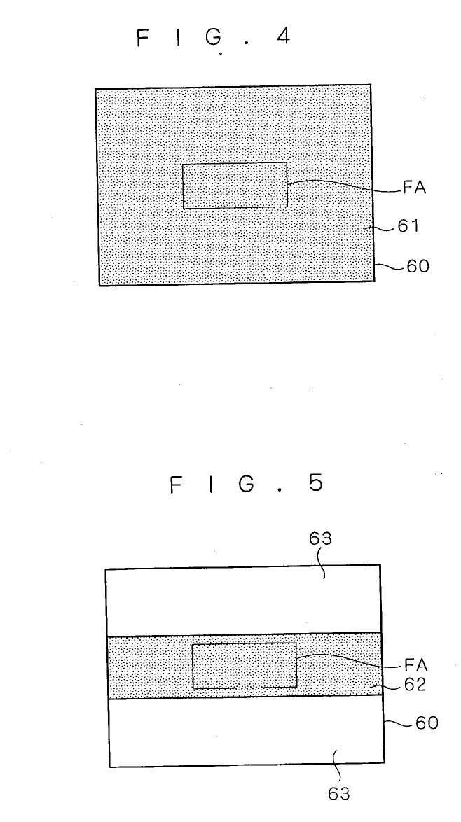

As shown in FIG. 1, a taking lens 3, an electronic flash 23 and an objective window of an optical viewfinder 22 are provided. The taking lens 3 has therein a unit of a plurality of lenses including a focusing lens 31 (see FIG. 3) which determines a focus state of a subject image. In a proper position on the rear side of the taking lens 3 in the digital camera 1, a CCD 21 as an image capturing device for obtaining image data (hereinafter, also simply referred to as “image”) of a subject via the lens unit is provided.

On the top face side of the digital camera 1, a shutter release button 25 and a main switch 24 for switching on/off states of a power source are disposed. The shutter release button 25 is a button of receiving an instruction of start of the auto-focus control or an instruction of taking a picture from the user and is a two-stage switch capable of detecting a half-pressed state (S1 state) and a full-pressed state (S2 state). In a side face of the digital camera 1, a card slot 26 into which a memory card 9 as a recording medium for recording image data and the like is removably inserted is formed.

As shown in FIG. 2, on the rear face side of the digital camera 1, an eye-piece window of the optical viewfinder 22, a mode switching lever 27 for switching the operation mode, a liquid crystal monitor 28 for displaying various images, and a button group 29 for performing various operations are provided.

The digital camera 1 has operations modes of an “image capturing mode” for obtaining image data of the subject and a “reproduction mode” of reproducing and displaying recorded image data. The operation modes are switched by operation of the mode switching lever 27.

The liquid crystal monitor 28 displays obtained image data, image data recorded on the memory card 9, and a menu screen for making various settings of the digital camera 1.

On the liquid crystal monitor 28 in an image capturing standby state, live-view display is performed in which image data obtained by the CCD 21 every predetermined time is displayed continuously with respect to time, and the user can perform framing while recognizing a displayed subject's image. At the time of the live-view display, a frame 28a indicative of a predetermined focusing area is displayed. The user performs framing so that a desired subject's image is disposed in the frame 28a, thereby setting a desired subject image into an in-focus state.

The button group 29 includes a display switching button 29a, a left button 29b, a right button 29c and a menu button 29d. The display switching button 29a is a button for setting whether an image is displayed on the liquid crystal monitor 28 in the image capturing standby state or not. Each time the display switching button 29a is depressed, the state of the liquid crystal monitor 28 is switched between display and undisplay.

The left button 29b, right button 29c and menu button 29d are buttons for mainly making various settings of the digital camera 1. By depressing the menu button 29d, a menu screen is displayed on the liquid crystal monitor 28. By operating the left button 29b and the right button 29c while recognizing the menu screen, various settings can be made.

1-2. Internal Configuration of Digital Camera

The internal configuration of the digital camera 1 will now be described. FIG. 3 is a functional block diagram showing main internal components of the digital camera 1.

The CCD 21 is constructed by a photosensitive part for accumulating signal charges by exposure, a vertical transfer part and a horizontal transfer part for transferring the signal charge, an output part and the like. The photosensitive part is constructed by a plurality of pixels to each of which a color filter of one of R (red), G (green) and B (blue) is adhered. The photosensitive part photoelectrically converts a light image of the subject formed by the lens unit of the taking lens 3 into signal charges (image data). The signal charges accumulated in the photosensitive part are once transferred to the vertical transfer part and, after that, to the horizontal transfer part every pixel line (hereinafter, referred to as “line”) in the lateral direction (horizontal direction), and sequentially outputted from the output part. Alternately, as the color filters adhered to the photosensitive part, color filters of complementary colors of a combination of C (cyan), M (magenta) and Y (yellow) may be employed.

The CCD 21 has, as image data output modes, a “normal mode” of outputting all of pixels of image data and an “area-limited mode” of outputting only a limited area including at least a focusing area in the image data.

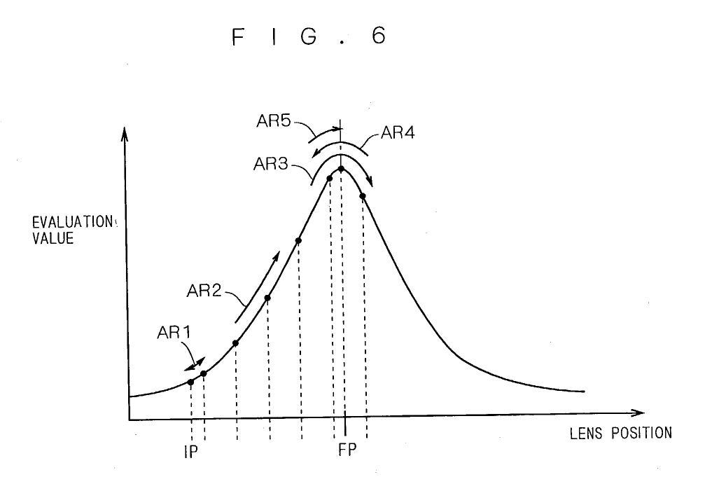

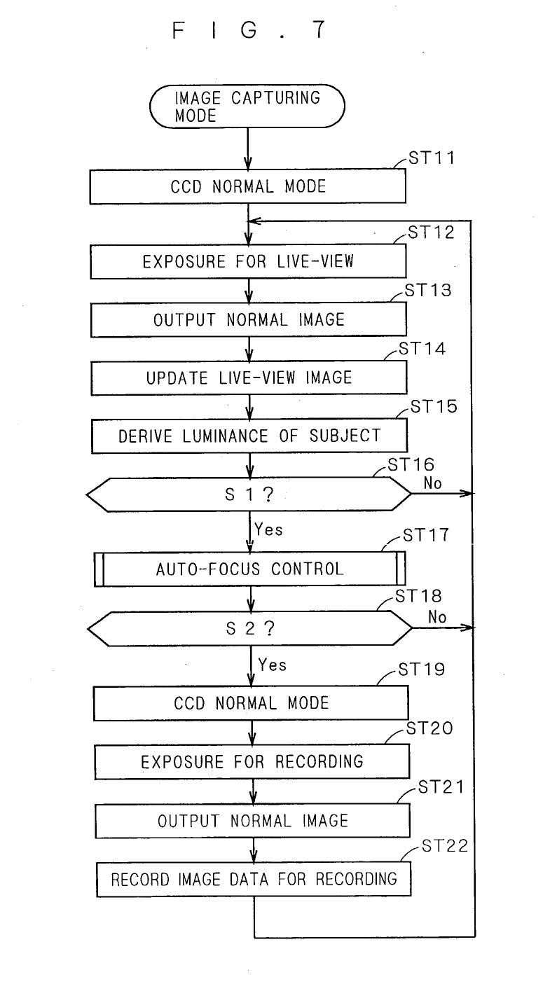

FIGS. 4 and 5 are diagrams showing image data 60 obtained by the CCD 21. An image of a main subject in the image data 60 is very likely to exist in an almost center portion. Thus, as shown in the diagrams, the almost center portion is assigned to a focusing area FA as an area on which focus is achieved.

When the CCD 21 is set in the normal mode, as shown in FIG. 4, all of pixels of the image data 60 are outputted as a normal image 61. On the other hand, when the CCD 21 is set in the area-limited mode, signal charges in areas 63 in the upper and lower parts in the image data 60 are discharged as unnecessary charges and an area-limited image 62 only in an area around the focusing area is outputted as shown in FIG. 5. The number of lines transferred and output of the area-limited image 62 is smaller than that of the normal image 61. Consequently, when the CCD 21 is set in the area-limited mode, as compared with the case where the CCD 21 is set in the normal mode, one frame of image data can be outputted at higher speed, and the number of frames of image data outputted per unit time, that is, a frame rate (unit: fps) can be increased.

When a period (inverse number of the frame rate) of outputting the normal image 61 from the CCD 21 in the normal mode is T1 and a period of outputting the area-limited image 62 in the area-limited mode is T2, it is preferable that the periods T1 and T2 have the following relation:

T1=n·T2 (where n is a natural number of 2 or larger) (1).

That is, preferably, the period T1 is longer than the period T2 by a multiple of a natural number. In the preferred embodiment, the period T1 is set to 1/60 second, and the period T2 is set to 1/180 second (n=3). That is, the CCD 21 outputs the normal image 61 at the frame rate of 60 fps in the normal mode and outputs the area-limited image 62 at the frame rate of 180 fps in the area-limited mode.

Referring again to FIG. 3, a timing generator 201 transmits various drive control signals to the CCD 21 on the basis of a signal inputted from an overall control unit 40. For example, the timing generator 201 transmits a vertical sync signal for transferring signals charges accumulated in the pixels in the CCD 21 to the vertical transfer part, a horizontal sync signal for transferring signal charges in one line from the vertical transfer part to the horizontal transfer part, an unnecessary charge discharging signal for discharging unnecessary charges in the pixels, an output mode switching signal of switching the output mode to the normal mode or the area-limited mode, and the like. Therefore, the output mode of the CCD 21 is switched by the timing generator 201.

A signal processing circuit 202 performs a predetermined analog signal process on image data (analog signal) outputted from the CCD 21. The signal processing circuit 202 has therein a CDS (Correlated Double Sampling) circuit and an AGC (Auto Gain Control) circuit, for reducing noises in image data by the CDS circuit and adjusts the level of image data by the AGC circuit.

An A/D converter 203 converts image data of an analog signal outputted from the signal processing circuit 202 to a digital signal. The value of each pixel outputted from the A/D converter 203 is expressed as a color component value of any of the color components of R, G and B.

An image memory 204 is a memory for storing image data outputted from the A/D converter 203 and has a storage capacity of at least one frame of the normal image 61.

An image processing unit 205 performs predetermined image processes of white balance correction, γ correction, resolution conversion, and compressing process on image data stored in the image memory 204.

A VRAM 210 is a buffer memory for storing screen image data to be displayed on the display screen of the liquid crystal monitor 28.

In the image capturing standby state, image data (normal image 61) outputted from the CCD 21 in the period T1 (1/60 second) is subjected to predetermined signal processes in the signal processing circuit 202 and the A/D converter 203, and the processed image data is stored in the image memory 204. The pixels are skipped at predetermined intervals in the image processing unit 205, thereby obtaining a live-view image (screen image data used for live-view display), and the live-view image is stored in the VRAM 210. The live-view image stored in the VRAM 210 is read at predetermined intervals by the overall control unit 40 and converted into a video signal, and the video signal is transmitted to the liquid crystal monitor 28. As a result, a subject image is displayed on the display screen of the liquid crystal monitor 28 (live-view display). A refresh rate (the number of times of rewriting the display screen per unit time) of the liquid crystal monitor 28 is set to 60 fps so as to coincide with the frame rate of outputting the normal image 61 from the CCD 21. A live-view image stored in the VRAM 210 is transmitted to the liquid crystal monitor 28 every 1/60 second. Image data obtained by the CCD 21 is sequentially smoothly displayed on the display screen of the liquid crystal monitor 28. Since the area-limited image 62 is not image data indicative of the whole area of the subject image, it cannot be used for such live-view display.

On the other hand, after the instruction of photographing by the shutter release button 25, image data (normal image 61) outputted from the CCD 21 as image data to be recorded is similarly subjected to the predetermined signal processes in the signal processing circuit 202 and the A/D converter 203, and the processed image is stored in the image memory 204. The image is subjected to a compressing process conformed with the JPEG method in the image processing unit 205, thereby obtaining a compressed image. The compressed image is recorded on the memory card 9 via a card I/F 206.

Image data outputted from the CCD 21 in the image capturing standby state is also inputted to an AF computing unit 207 and a luminance computing unit 208 and used for an exposure control and a focusing control.

The AF computing unit 207 derives a focus evaluation value used for the auto-focus control by using image data of both the normal image 61 and the area-limited image 62. Concretely, pixels in the focusing area in image data are used for computation and a contrast value is obtained from the pixels in the focusing area and used as a focus evaluation value. The computed focus evaluation value is inputted to the overall control unit 40.

The luminance computing unit 208 derives a luminance value of the subject used for exposure control by using the normal image 61. Concretely, a luminance component value of a pixel in the input image data is obtained and an average value in all of pixels of obtained luminance component values is computed as a luminance value of the subject. The computed luminance value of the subject is inputted to the overall control unit 40.

A lens driving unit 209 drives the focusing lens 31 in the taking lens 3, an aperture in the taking lens 3 for determining an incident light amount, and the like. The lens driving unit 209 is electrically connected to the overall control unit 40 and drives the focusing lens 31 in the taking lens 3 and the like on the basis of a signal inputted from the overall control unit 40.

An operation input unit 20 is an operation member shown as one function block including the shutter release button 25, main switch 24, mode switching lever 27, button group 29 and the like. The operation of the operation input unit 20 is inputted as a signal to the overall control unit 40.

The overall control unit 40 is to control operations of the above-described members of the digital camera 1 in a centralized manner, and includes a CPU 41 for performing various computing processes, a RAM 42 as a work area for computation, and a ROM 43 in which a control program and the like is stored.

The various functions of the overall control unit 40 are realized when the CPU 41 executes computing processes in accordance with a control program stored in the ROM 43. Such a control program is usually prestored in the ROM 43. Alternately, a new control program can be also stored in the ROM 43 by reading it from the memory card 9 or the like. In FIG. 3, an exposure control unit 51, a display control unit 52 and an AF control unit 53 are schematically shown as function blocks as a part of the functions realized when the CPU 41 executes computing operations in accordance with a control program.

The exposure control unit 51 executes an exposure control. Concretely, the exposure control unit 51 determines a shutter speed (corresponding to charge accumulation time of the CCD 21) and an aperture value (corresponding to the diameter of the opening of the aperture) on the basis of a luminance value of the subject inputted from the luminance computing unit 208 and a predetermined program chart. The exposure control unit 51 transmits signals to the timing generator 201 and the lens driving unit 209 so as to achieve the determined shutter speed and aperture value. When the subject has low luminance and exposure is insufficient, the signal processing circuit 202 is caused to adjust the level of image data outputted from the CCD 21 so as to correct improper exposure.

The display control unit 52 controls the state of the display screen of the liquid crystal monitor 28 and the like. The display control unit 52 reads the screen image data (live-view image or the like) stored in the VRAM 210 at predetermined intervals, converts the image data into a video signal, and transmits the video signal to the liquid crystal monitor 28. The display control unit 52 also performs controls of displaying a predetermined menu screen on the liquid crystal monitor 28 in accordance with an operation of the menu button 29d and the like, and switching the state of the liquid crystal monitor 28 between the display state and the undisplay state in accordance with the operation of the display switching button 29a.

The AF control unit 53 monitors the focus evaluation value inputted from the AF computing unit 207 and performs the auto-focus control for driving the focusing lens 31 in the taking lens 3 so that a subject image in the focusing area in image data is in focus. The AF control unit 53 controls the driving of the focusing lens 31 by transmitting a predetermined signal to the lens driving unit 209.

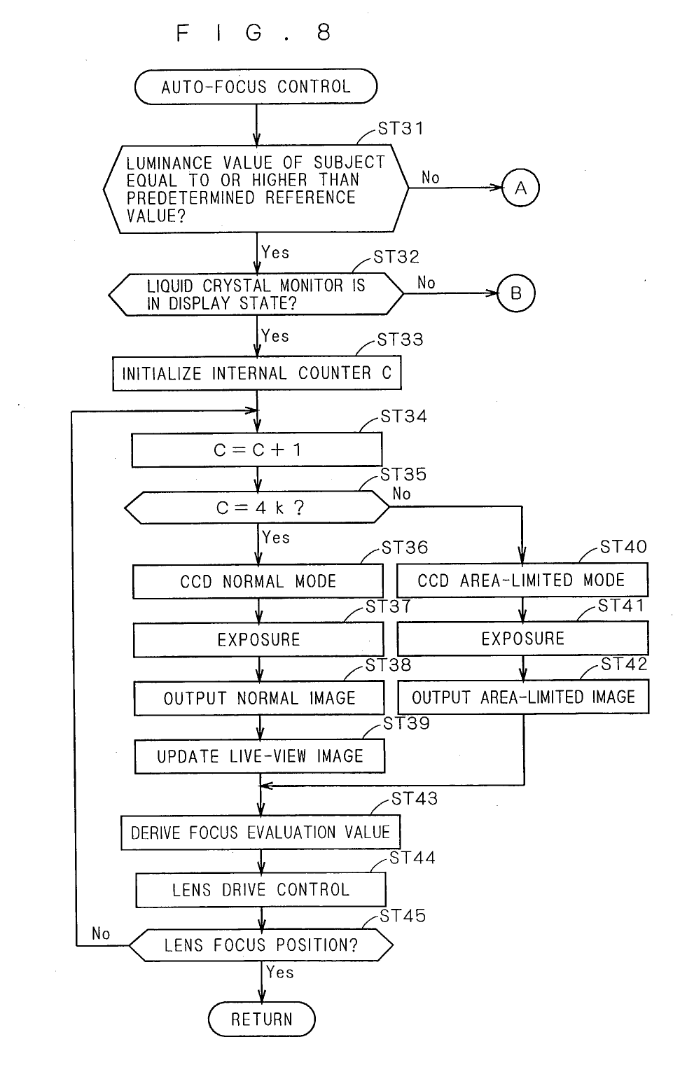

FIG. 6 is a diagram showing an example of the relation between the position of the focusing lens 31 (hereinafter, referred to as “lens position”) and the focus evaluation value (contrast). As shown in the diagram, the focus evaluation value changes according to the lens position and becomes a maximum value when a given lens position is provided. The AF control unit 53 obtains the given lens position where the evaluation value becomes the maximum value as a focus position FP and moves the focusing lens 31 to the focus position FP.

Concretely, when it is assumed that the lens position before the auto-focus control (hereinafter, referred to as “initial position”) is a position indicated by reference characters IP, first, the focusing lens 31 is driven a little from the initial position IP (arrow AR1) and evaluation values respectively obtained when the focusing lens 31 is placed at a plurality of positions are compared with each other. From the result of comparison of the evaluation values, the driving direction of the focusing lens 31 is determined and the focusing lens 31 is driven at relatively high speed in the determined driving direction (direction of arrow AR2). Evaluation values sequentially obtained during the driving are monitored to determine whether decrease from one evaluation value to another evaluation value is caused or not.

In the case when the decrease is caused (arrow AR3), the lens position passes through the focus position FP and comes near the focus position FP. Consequently, the driving direction of the focusing lens 31 is switched to the opposite direction (direction of the arrow AR4) to drive the focusing lens 31. After the lens position is brought in the vicinity of the focus position FP, the focusing lens 31 is driven at relatively low speed for the reason that in order to adjust the lens position to the focus position FP at high precision, a change in the evaluation value caused by a small difference of the lens position has to be obtained. After that, the driving direction of the focusing lens 31 is switched as necessary (arrow AR5), the focus evaluation value is monitored, and the focusing lens 31 is finally moved to the position FP where the evaluation value becomes the maximum value.

The AF control unit 53 transmits a signal of instructing switching of the output mode of the CCD 21 to the timing generator 201 in order to promptly perform the auto-focus control operation. The details will be described later.

1-3. Outline of Operation of Digital Camera

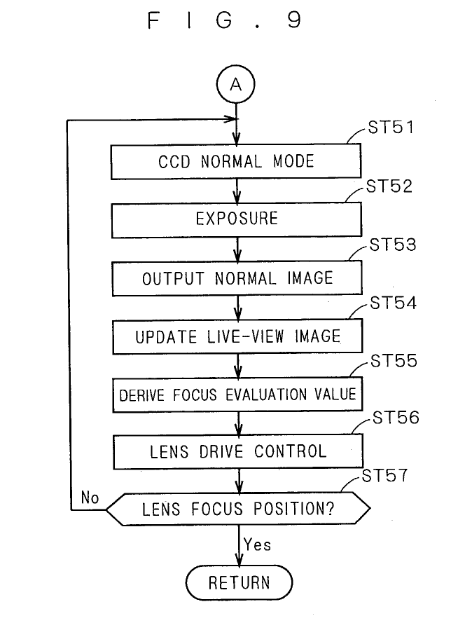

The operation in the image capturing mode of the digital camera 1 will now be described. FIG. 7 is a diagram schematically showing the operation in the image capturing mode of the digital camera 1.

When the image capturing mode is set, the digital camera 1 enters an image capturing standby state, and performs a live-view operation of displaying image data outputted at the rate of 60 fps from the CCD 21 onto the liquid crystal monitor 28.

First, the output mode of the CCD 21 is set to the normal mode of outputting the normal image 61 (step ST11). Subsequently, exposure for live-view display is performed in the CCD 21 (step ST12) and the normal image 61 is outputted (step ST13). The output normal image 61 is subjected to the predetermined processes in the signal processing circuit 202, A/D converter 203, image memory 204 and the image processing unit 205, thereby obtaining a live-view image. The live-view image is displayed on the liquid crystal monitor 28 (step ST14).

On the other hand, the normal image 61 is also inputted to the luminance computing unit 208 and the luminance value of the subject is derived. The computed luminance value of the subject is inputted to the overall control unit 40, and the shutter speed and the aperture value are determined by the exposure control unit 51 on the basis of the luminance value (step ST15).

The operation (live-view operation) in steps ST12 to ST15 is repeated every 1/60 second until the shutter release button 25 is half-pressed (so far as “No” is indicated in step ST16). In other words, the normal image 61 is outputted from the CCD 21 at intervals of 1/60 second, and the live-view image stored in the VRAM 210 is also updated at the intervals of 1/60 second.

In such image capturing standby state, when the shutter release button 25 is half-pressed (“Yes” in step ST16), the auto-focus control is performed by the AF control unit 53 and the focusing lens 31 is moved to the focus position FP (step ST17).

After the auto-focus control is finished, a state where full-press of the shutter release button 25 is waited is set (step ST18). When the shutter release button 25 is full-pressed, the output mode of the CCD 21 is set to the normal mode of outputting the normal image 61 (step ST19), exposure for recording is performed on the CCD 21 (step ST20), and the normal image 61 is outputted (step ST21). The output normal image 61 is subjected to the predetermined processes in the signal processing circuit 202, A/D converter 203, image memory 204, and image processing unit 205, thereby obtaining a compressed image. The compressed image is recorded on the memory card 9 (step ST22).

After recording the compressed image, or in the case the shutter release button 25 is half-pressed but is not full-pressed (No in step ST18), the flow returns again to step ST12 and the image capturing standby state is set.

1-4. Auto-Focus Control

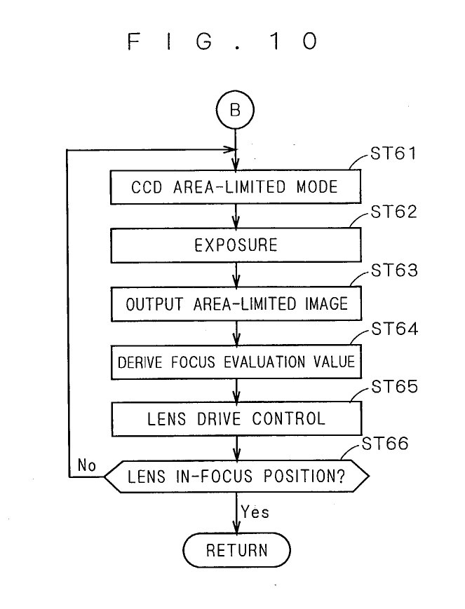

The details of the auto-focus control operation (step ST17 in FIG. 7) of the digital camera 1 will now be described. FIGS. 8 to 10 are diagrams showing the flow of the auto-focus control operation.

In the digital camera 1, the method of auto-focus control is made vary according to the luminance of a subject. Consequently, at the time of performing the auto-focus control, whether the luminance value of the subject inputted from the luminance computing unit 208 is equal to or higher than a predetermined reference value or not is determined by the AF control unit 53 (step ST31). When the luminance value of the subject is equal to or higher than the reference value, operations in step ST32 and subsequent steps are performed. When the luminance value is lower than the predetermined reference value, operations in step ST51 and subsequent steps in FIG. 9 are performed.

When the luminance value of the subject is equal to or higher than the predetermined reference value, the digital camera 1 makes the auto-focus control method vary according to whether the state of the liquid crystal monitor 28 is the display state or the undisplay state. Consequently, when the luminance value of the subject is equal to or higher than the predetermined reference value, whether the state of the liquid crystal monitor 28 is the display state or the undisplay state is determined by the AF control unit 53 on the basis of a signal from the display control unit 52 (step ST32). When the state of the liquid crystal monitor 28 is the display state, operations in step ST33 and subsequent steps are performed. When the state of the liquid crystal monitor 28 is the undisplay state, operations in step ST61 and subsequent steps in FIG. 10 are performed.

The operations of the auto-focus control (step ST33 and subsequent steps) in the case where the luminance value of the subject is equal to or larger than the predetermined reference and the state of the liquid crystal monitor 28 is the display state will be described below.

First, an internal counter C is initialized and set to “0” (step ST33). The internal counter C indicates the number of deriving times of the focus evaluation value in the auto-focus control (=the number of exposure times of image data for deriving the evaluation value). In the auto-focus control, the processes in steps ST35 to ST44 are repeated until the lens position becomes a focus position (so far as “No” is indicated in step ST45). Before starting the series of processes, the internal counter C is incremented (step ST34).

After that, whether the internal counter C indicates a multiple of 4 (C=4k, k is a natural number) or not is determined (step ST35).

In the case where the internal counter C is a multiple of 4 (“No” in step ST35), the output mode of the CCD 21 is set to the normal mode by signals from the AF control unit 53 and the timing generator 201. That is, in a manner similar to the live-view operation, a setting of outputting the normal image 61 in 1/60 second is made (step ST36).

Subsequently, exposure is made in the CCD 21 (step ST37), and the normal image 61 is outputted from the CCD 21 (step ST38). In a manner similar to the above, the output normal image 61 is subjected to the predetermined processes in the signal processing circuit 202, A/D converter 203, image memory 204, and image processing unit 205, thereby obtaining a live-view image. The live-view image is stored in the VRAM 210 and, after that, displayed on the liquid crystal monitor 28. That is, the live-view image stored in the VRAM 210 is updated (step ST39).

The normal image 61 is also inputted to the AF computing unit 207 and the focus evaluation value is derived (step ST43). The derived evaluation value is inputted to the overall control unit 40 and, on the basis of the evaluation value, the driving of the focusing lens 31 is controlled by the AF control unit 53 (step ST44).

On the other hand, when the internal counter C does not indicate a multiple of 4 (No in step ST35), the output mode of the CCD 21 is set to the area-limited mode by signals from the AF control unit 53 and the timing generator 201. That is, a setting of outputting the area-limited image 62 is made in 1/180 second (step ST40).

Subsequently, exposure is made in the CCD 21 (step ST41) and the area-limited image 62 is outputted from the CCD 21 (step ST42). The output area-limited image 62 is inputted to the AF computing unit 207 and the focus evaluation value is derived (step ST43). On the basis of the derived evaluation value, the driving of the focusing lens 31 is controlled (step ST44). At this time, as described above, the area-limited image 62 is not used as a live-view image. However, when the output mode of the CCD 21 is a normal mode, the live-view image stored in the VRAM 210 is held as it is under control of the display control unit 52. The state of the display screen on the liquid crystal monitor 28 on which a subject image is displayed is held and the subject image is appropriately displayed on the display screen of the liquid crystal monitor 28. Consequently, even in the case where the output mode of the CCD 21 is set to the area-limited mode, the user can recognize the subject image.

The above-described operations are repeated and the focusing lens 31 is moved finally to the focus position (step ST45).

FIG. 8 shows, for convenience, that the various processes are performed between exposure of the image data (steps ST37 and ST41), and the next exposure. In reality, however, the next exposure is made almost without time interval. Therefore, the CCD 21 repeats continuously the operation in which the output (every 1/180 second) of the area-limited image in the area-limited mode is performed three times (1/180 second×3=1/60 second) and the output of the normal image 61 in the normal mode is performed once (every 1/60 second). That is, the output mode of the CCD 21 is switched between the area-limited mode and the normal mode at the intervals of 1/60 second. The interval of 1/60 second of switching the output mode coincides with the period T1 in which the CCD 21 outputs the normal image 61.

In the case where the periods T1 and T2 have the relation of the above equation (1), if the number of repeating times of outputting the area-limited image 62 in the area-limited mode is “n” in the equation (1) (n=3 in the preferred embodiment), the interval of switching the output mode of the CCD 21 coincides with the period T1. Therefore, when the internal counter C is determined to indicate a multiple of “n+1” in step ST35, the interval of switching the output mode of the CCD 21 coincides with the period T1.

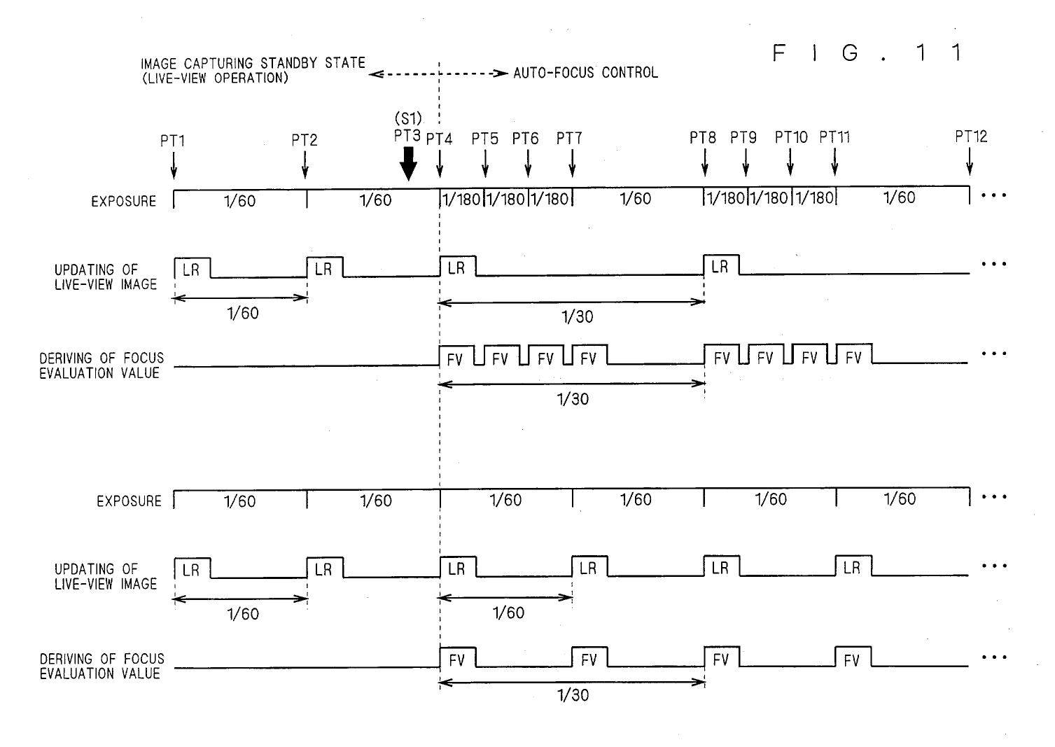

FIG. 11 is a time chart of which lateral axis indicates a time base and shows processes performed at the time of shift from the live-view operation in the image capturing state to the auto-focus control. The upper part in FIG. 11 shows processes (operation in FIG. 8) in the case of switching the output mode of the CCD 21 at predetermined intervals, and the lower part in FIG. 11 shows processes of the case where the output mode of the CCD 21 is unchanged from the normal mode. PT3 in FIG. 11 denotes a time point when the shutter release button 25 is half-pressed.

As shown in FIG. 11, in the live-view operation in the image capturing standby state, the normal image 61 is outputted from the CCD 21 at the intervals of 1/60 second and, accordingly, updating LR of a live-view image in the VRAM 210 is performed every 1/60 second (time points PT1 to PT4).

For example, as shown in the lower part in FIG. 11, in the case where the output mode of the CCD 21 is not changed from the normal mode at the time of the auto-focus control, also after the time point PT4, the normal image 61 is outputted at the intervals of 1/60 second. At the same intervals of 1/60 second, the updating LR of the live-view image and deriving FV of the focus evaluation value are performed.

On the other hand, in the case of switching the output mode of the CCD 21 at predetermined intervals as in the digital camera 1, as shown in the upper part in FIG. 11, when the shutter release button 25 is half-pressed (time point PT3), in response to this, the output mode of the CCD 21 is switched to the area-limited mode from the next exposure start time point PT4 of the CCD 21. Three frames of the area-limited image 62 are outputted every 1/180 second (time points PT5 to PT7). Subsequently, the output mode of the CCD 21 is switched to the normal mode at time point PT7. In 1/60 second after the time point PT7, one frame of the normal image 61 is outputted (time point PT8). After that, the area-limited image 62 and the normal image 61 are outputted at the same intervals as described above (time points PT8 to PT12 . . . ).

In such a case, the normal image 61 is outputted every 1/30 second. The updating LR of the live-view image in the VRAM 210 is performed every 1/30 second, i.e., at the same intervals as the output intervals of the normal image 61. During the period between the updating LR of a live-view image and the next updating LR, the state of the display screen of the liquid crystal monitor 28 is held. As compared with the live-view operation in the image capturing standby state or the case of the lower part in FIG. 11, smoothness of display slightly deteriorates. However, the state of the subject image can be sufficiently grasped, and framing can be carried out.

The deriving FV of the focus evaluation value is performed four times in 1/30 second between the time point PT4 and the time point PT8. Subsequently, at the same intervals, the focus evaluation value is derived. On the other hand, in the period from the time point PT4 to the time point PT8 in the lower part in FIG. 11, the deriving FV of the focus evaluation value is performed only twice. That is, by switching the output mode of the CCD 21, the number of deriving FV times of the focus evaluation value per unit time can be increased. This corresponds to increase in the number of times of grasping a change in the evaluation value per unit time. Consequently, the driving speed of the focusing lens 31 can be increased without deteriorating precision in determining the lens position. Since a change in the evaluation value according to the lens position can be grasped precisely, the lens position determining speed can be improved. Thus, the auto-focus control can be performed promptly with high precision.

Since the periods T1 and T2 have the relation of the equation (1) and the output mode is switched in the period T1, it is unnecessary to change timings for processes on the normal image 61. Specifically, at the time of the auto-focus control, the normal image 61 and the area-limited image 62 are outputted continuously with respect to time. For the normal image 61, various image processes, generation of a live-view image, and the like are necessary. The processes on the normal image 61 can be performed at a timing similar to that of the normal mode. Consequently, without providing a new mechanism for synchronizing the processes, various processes can be performed on the normal image 61.

For example, in the preferred embodiment, the refresh rate of the liquid crystal monitor 28 is 60 fps in accordance with to the period T1. At the time of the auto-focus control, a live-view image is updated every 1/30 second, so that a new live-view image is obtained reliably at the ratio of once every twice of changing the screen of the liquid crystal monitor 28. Consequently, a live-view can be displayed relatively smoothly without changing the refresh rate of the liquid crystal monitor 28, display timings and the like.

The operations (in step ST51 and subsequent steps in FIG. 9) of the auto-focus control in the case where the luminance value of the subject is less than a predetermined reference value (“No” in step ST31 in FIG. 8) will be described.

When the luminance value of the subject is relatively low, shutter speed of relatively long time is necessary. The shutter speed depends on the output period of image data of the CCD 21. Therefore, when the output mode of the CCD 21 is switched to the area-limited mode in the case where the luminance value of the subject is relatively low, the output period becomes short. This results in insufficient exposure, so that a valid focus evaluation value cannot be obtained. If the level of image data is adjusted by the signal processing circuit 202 and the like in order to solve the problem, the level of noise in the image data increases and, as a result, precision of the auto-focus control deteriorates.

In the case where the luminance value of the subject is lower than the predetermined reference value, also in the auto-focus control, the output mode of the CCD 21 is not changed from the normal mode in order to obtain a focus evaluation value of relatively high precision.

That is, the output mode of the CCD 21 is set to the normal mode (step ST51), exposure is made in the CCD 21 (step ST52), and the normal image 61 is outputted from the CCD 21 (step ST53). In a manner similar to the above, the output normal image 61 is subjected to the predetermined processes in the signal processing circuit 202, A/D converter 203, image memory 204 and image processing unit 205, and a live-view image in the VRAM 210 is updated (step ST54).

The normal image 61 is also inputted to the AF computing unit 207 and the focus evaluation value is computed (step ST55). The derived evaluation value is inputted to the overall control unit 40 and the driving of the focusing lens 31 is controlled by the AF control unit 53 on the basis of the evaluation value (step ST56). Such a process is repeated until the focusing lens 31 is moved to the focus position (so far as “No” is indicated in step ST57).

In the digital camera 1, only when the luminance value of the subject is equal to or higher than the predetermined reference value, the output mode of the CCD 21 is switched. Therefore, deterioration in precision of the auto-focus control can be prevented.

The operations (step ST61 and subsequent steps in FIG. 10) of the auto-focus control in the case where the luminance value of the subject is equal to or higher than the predetermined reference value and the state of the liquid crystal monitor 28 is the undisplay state (“No” in step ST32 in FIG. 8) will now be described.

When the state of the liquid crystal monitor 28 is the undisplay state, it is unnecessary to output the normal image 61 for displaying a live-view from the CCD 21. Consequently, in the auto-focus control, the output mode of the CCD 21 can remain as the area-limited mode.

Specifically, the output mode of the CCD 21 is set to the area-limited mode (step ST61), exposure is made in the CCD 21 (step ST62), and the area-limited image 62 is outputted from the CCD 21 (step ST63). The output area-limited image 62 is inputted to the AF computing unit 207 and a focus evaluation value is derived (step ST64). Further, on the basis of the derived evaluation value, the driving of the focusing lens 31 is controlled (step ST65). Such a process is repeated until the focusing lens 31 is moved to the focus position (so far as “No” is indicated in step ST66).

As described above, in the digital camera 1, when the state of the liquid crystal monitor 28 is the undisplay state, the output mode of the CCD 21 is set as the area-limited mode. Consequently, the number of deriving times of the focus evaluation value per unit time is further increased, and the auto-focus control can be performed more promptly.

2. Second Preferred Embodiment

A second preferred embodiment of the present invention will now be described. In the first preferred embodiment, when the luminance value of the subject is equal to or higher than the predetermined reference value and the state of the liquid crystal monitor 28 is the display state, the output mode of the CCD 21 is switched as the shutter release button 25 is half-pressed. In the second preferred embodiment, when the lens position is brought in the vicinity of the focus position, the output mode is switched.

The configuration of the digital camera 1 of the second preferred embodiment is similar to that shown in FIGS. 1 to 3, and the outline of operations in the image capturing mode is similar to that shown in FIG. 7, so that detailed description will not be repeated here.

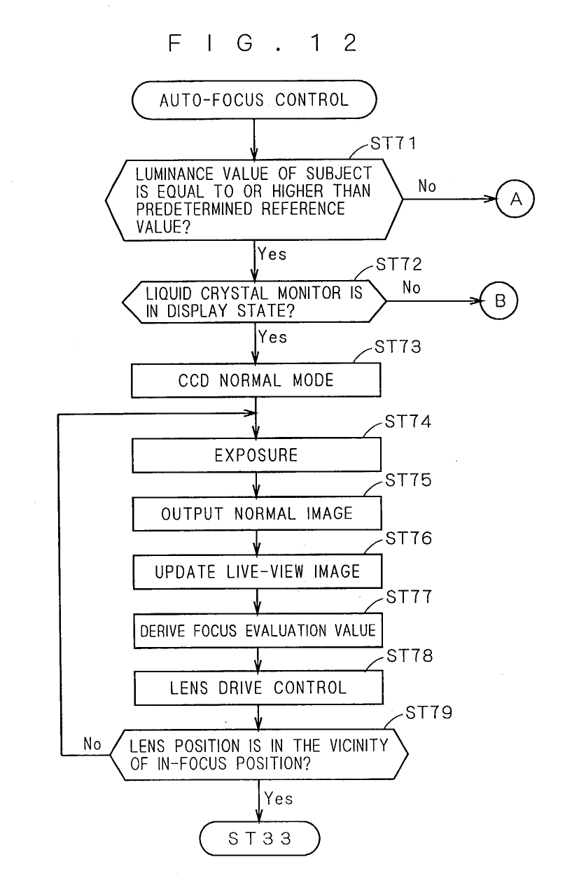

FIG. 12 is a diagram showing the flow of the auto-focus control operation of the digital camera 1 in the second preferred embodiment. First, in a manner similar to the first preferred embodiment, whether the luminance value of the subject is equal to or higher than a predetermined reference value is determined (step ST71) and whether the state of the liquid crystal monitor 28 is the display or undisplay state is determined (step ST72). In a manner similar to the first preferred embodiment, when the luminance value of the subject is lower than the predetermined reference value, the operations in step ST51 and subsequent steps in FIG. 9 are performed. In the case where the state of the liquid crystal monitor 28 is the undisplay state, the operations in step ST61 and subsequent steps in FIG. 10 are performed.

In the preferred embodiment, the operations (in step ST73 and subsequent steps) of the auto-focus control in the case where the luminance value of the subject is equal to or higher than a predetermined reference value and the state of the liquid crystal monitor 28 is the display state will be described.

First, the output mode of the CCD 21 is set to the normal mode (step ST73). Subsequently, exposure is made in the CCD 21 (step ST74) and the normal image 61 is outputted from the CCD 21 (step ST75). The output normal image 61 is subjected to predetermined processes in the signal processing circuit 202, A/D converter 203, image memory 204, and image processing unit 205, thereby obtaining a live-view image. The live-view image in the VRAM 210 is updated (step ST76).

The normal image 61 is also inputted to the AF computing unit 207 and the focus evaluation value is derived (step ST77). The derived evaluation value is inputted to the overall control unit 40 and, on the basis of the evaluation value, the driving of the focusing lens 31 is controlled by the AF control unit 53 (step ST78).

Subsequently, whether the lens position is brought in the vicinity of the focus position or not is determined by the AF control unit 53 (step ST79). Concretely, whether the evaluation value monitored decreases or not is determined. If the evaluation value decreases, it is determined that the lens position is brought in the vicinity of the focus position (see FIG. 6). If the lens position is not brought in the vicinity of the focus position, the flow returns again to step ST74 and the above-noted series of processes is repeated while the output mode of the CCD 21 is not changed from the normal mode.

On the other hand, when the lens position is brought in the vicinity of the focus position, the flow advances to step ST33 in FIG. 8 and, after that, operations similar to those in the first preferred embodiment are executed. To be specific, in response to the determination that the lens position is brought in the vicinity of the focus position by the AF control unit 53, the output mode of the CCD 21 is switched between the area-limited mode and the normal mode at predetermined intervals (1/60 second).

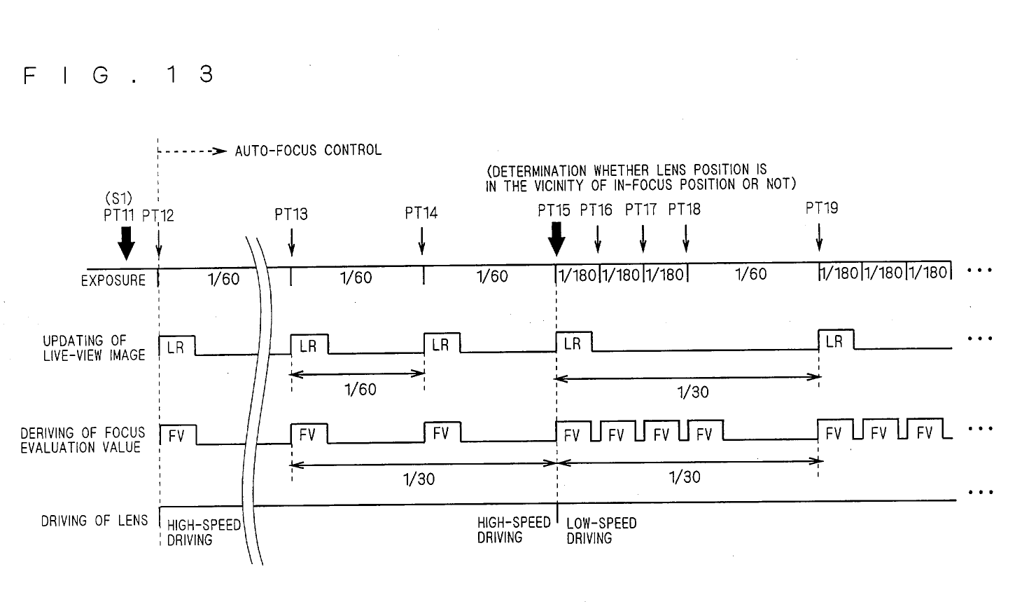

FIG. 13 is a time chart of which lateral axis indicates a time base and shows processes performed in the auto-focus control of the digital camera 1 of the second preferred embodiment. In FIG. 13, PT11 denotes a time point when the shutter release button 25 is half-pressed and PT15 indicates a time point when it is determined that the lens position is brought in the vicinity of the focus position.

In the digital camera 1 of the preferred embodiment, when the shutter release button 25 is half-pressed (time point PT11), the operation shifts to the auto-focus control while the output mode of the CCD 21 remains as the normal mode (time point PT12). Therefore, the normal image 61 is outputted from the CCD 21 at the intervals of 1/60 second, and updating LR of a live-view image and deriving FV of the focus evaluation value are performed at the same intervals of 1/60 second (time points PT12 to PT15).

When it is determined that the lens position is brought in the vicinity of the focus position (time point PT15), the output mode of the CCD 21 is switched to the area-limited mode, in response to the determination. Three frames of the area-limited image 62 are output at the intervals of 1/180 second (time points PT16 to PT18) and, subsequently, the output mode of the CCD 21 is switched to the normal mode at time point PT18. In a 1/60 second after the time point PT18, one frame of the normal image 61 is outputted (time point PT19). Subsequently, the area-limited image 62 and the normal image 61 are outputted in the same manner, i.e., at intervals at 1/30 second (time point PT19 . . . ).

Until the time point PT15 when it is determined that the lens position is brought in the vicinity of the focus position, the updating LR of the live-view image is performed every 1/60 second. At and after the time point PT15, the updating LR of the live-view image is performed every 1/30 second. Therefore, the live-view image is smoothly displayed on the liquid crystal monitor 28, until the time point PT15. Thus, the period in which smoothness of the live-view display deteriorates can be shortened.

Until the time point PT15, the focusing lens 31 is driven at relatively high speed. After the time point PT15, the focusing lens 31 is driven at relatively low speed. Meanwhile, the deriving FV of the focus evaluation value is performed twice during a 1/30 second (every 1/60 second) until the time point PT15. After the time point PT15, the deriving FV is performed four times in a 1/30 second. Therefore, after the time point PT15, the number of times of grasping a change in the evaluation value per unit time increases, and the lens position can be determined with high precision without relatively decreasing the speed of the focusing lens 31. Thus, the auto-focus control can be performed promptly with high precision.

3. Third Preferred Embodiment

3-1. Configuration of Digital Camera

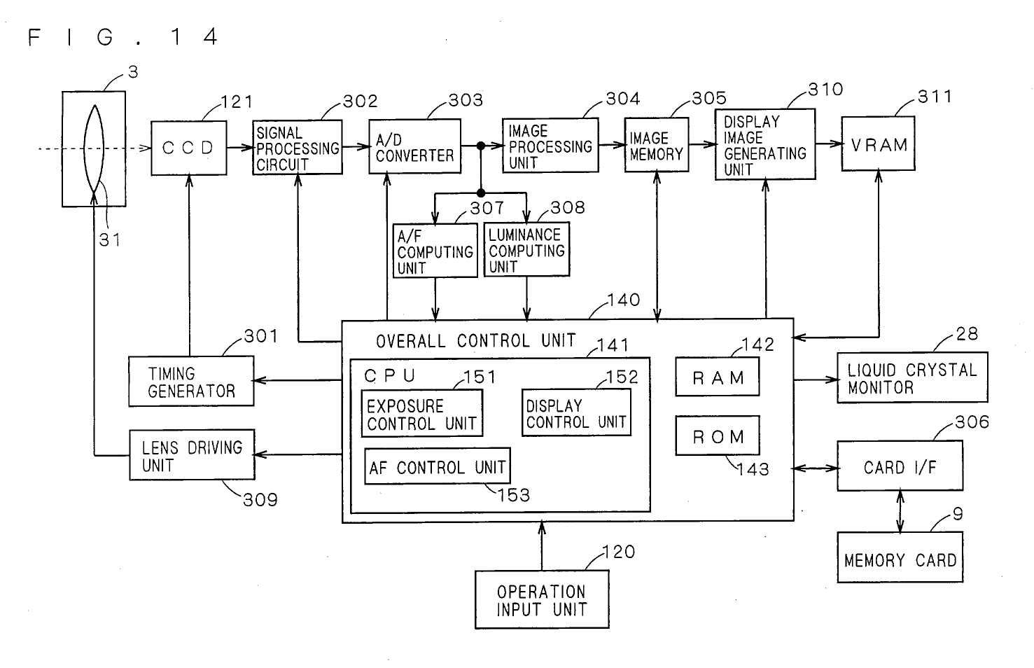

A third preferred embodiment of the present invention will now be described. The appearance of the digital camera 1 of the third preferred embodiment is similar to that shown in FIGS. 1 and 2. In the third preferred embodiment, a CCD 121 is used in place of the CCD 21 (see FIG. 14). FIG. 14 is a diagram showing main internal components of the digital camera 1 of the third preferred embodiment as functional blocks.

The CCD 121 has, in a manner similar to the CCD 21, a photosensitive part for accumulating signal charges by exposure, a vertical transfer part and a horizontal transfer part for transferring the signal charge, an output part and the like.

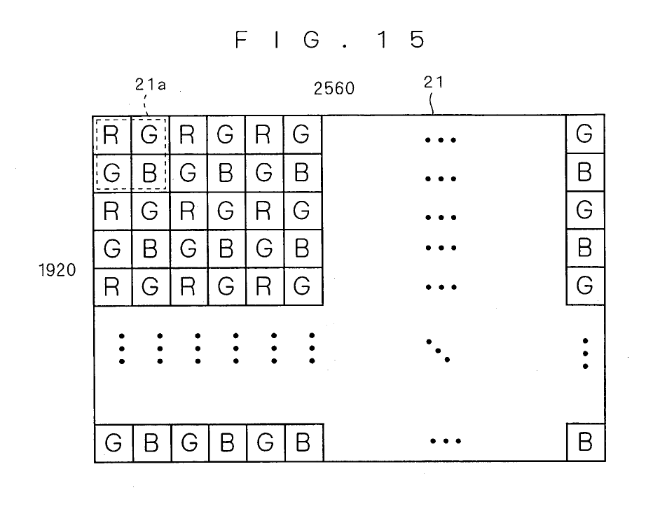

FIG. 15 is a diagram showing an example of a pixel array of the photosensitive part in the CCD 121. As shown in FIG. 15, the pixel array of the photosensitive part is a two-dimensional array of 2560 pixels in a horizontal direction×1920 pixels in a vertical direction (2560 horizontal pixels×1920 vertical pixels). The array of color filters (color components) adhered to the pixels is a Bayer matrix. In an area 21a of neighboring four pixels, two pixels of the G filter, one pixel of the R filter and one pixel of the B filter are included.

The CCD 121 not only outputs all of the pixels of the image data but also can read the image data while skipping lines at a predetermined ratio and output the image data obtained by skipping some pixels in the vertical direction. Various output methods of image data are preset as output modes of the CCD 121. The CCD 121 of the third preferred embodiment has, as its output modes, the “normal mode” of outputting all of pixels of image data and a “first compression mode” and a “second compression mode” for outputting the compressed image data obtained by skipping.

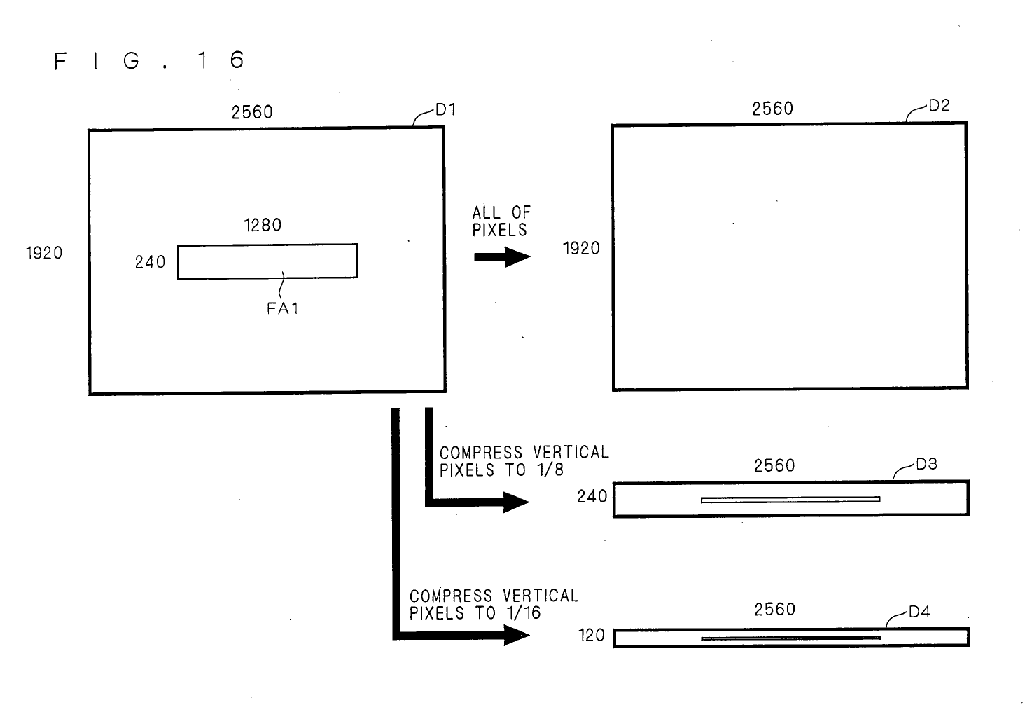

FIG. 16 is a diagram for describing image data outputted from the CCD 121. In the photosensitive part in the CCD 121, image data (hereinafter, referred to as “obtained image data”) D1 constructed by a two-dimensional array of 2560 horizontal pixels×1920 vertical pixels is obtained. An area FA1 of 1280 horizontal pixels×240 vertical pixels in the center of the obtained image data D1 is set as a focusing area.

When the output mode of the CCD 121 is set to the “normal mode”, all of the pixels of the obtained image data D1 is read out, and a normal image D2 having 2560 horizontal pixels×1920 vertical pixels is outputted.

On the other hand, when the output mode is set to the “first compression mode”, some of lines of the obtained image data D1 are skipped so as to read the lines at a rate of ⅛. Consequently, a first compressed image D3 having 2560 horizontal pixels×240 vertical pixels obtained by reducing the pixels in the vertical direction to ⅛ is outputted. When the output mode is set to the “second compression mode”, some of lines in the obtained image data D1 are skipped so as to read the lines at a rate of 1/16. A second compressed image D4 having 2560 horizontal pixels×120 vertical pixels obtained by reducing pixels in the vertical direction to 1/16 is outputted.

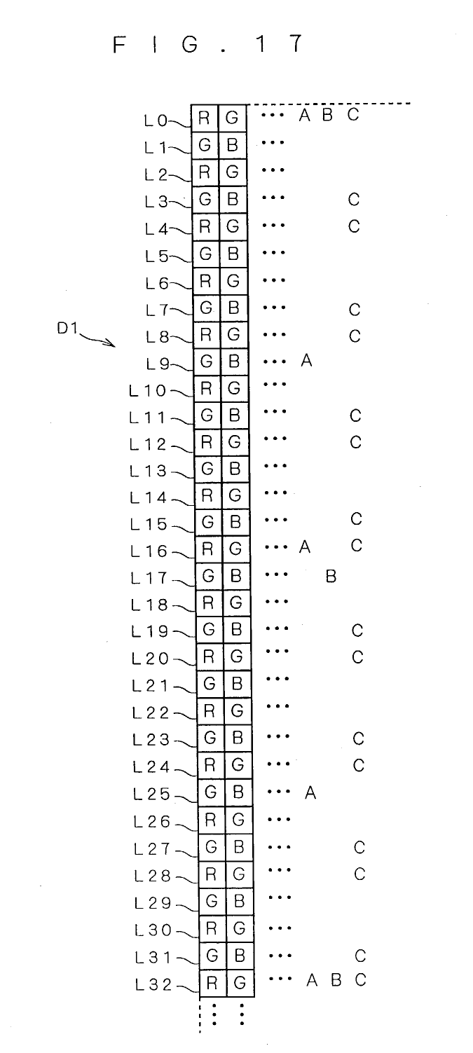

FIG. 17 is a diagram showing an area as a part of the obtained image data D1 and reference characters and numerals L0 to L32 indicate lines of the obtained image data D1. The line L0 corresponds to the uppermost line of the obtained image data D1, the lines are called as the 0-th line L0, the 1st line L1, . . . in order from the uppermost line L0.

The intervals of lines read in the “first compression mode” or “second compression mode” are not constant so that color components of pixels can be arranged in accordance with a Bayer array pattern in each of the first compressed image D3 and the second compressed image D4. Concretely, in the case of the “first compression mode”, lines indicated by reference character A in the diagram, i.e. the 0th line L0, the 9th line L9, the 16th line L16, the 25th line L25, . . . are read. In the case of the “second compression mode”, lines indicated by reference character B in the diagram, i.e. the 0th line L0, the 17th line L17, the 32nd line L32, the 49th line, . . . are read out.

In the case where the output mode is set to the “first compression mode” or “second compression mode”, the number of lines to be outputted is smaller than that in the case where the output mode is set to the “normal mode”. Consequently, image data per frame can be outputted at higher speed, and the amount of image data to be outputted per unit time, that is, the frame rate can be increased. Since the number of lines to be outputted in the “second compression mode” is smaller than that in the “first compression mode”, the frame rate can be further increased (image data can be outputted at higher speed). In the CCD 121 of the preferred embodiment, the frame rate becomes 30 fps (interval of a 1/30 second) in the “first compression mode”, and the frame rate becomes 60 fps (interval of a 1/60 second) in the “second compression mode”. That is, the amount of image data to be outputted per unit time can be doubled in the “second compression mode” as compared with the “first compression mode”.

The output mode of the CCD 121 is set by a signal from a timing generator 301 (see FIG. 14). The timing generator 301 transmits various drive control signals to the CCD 121 on the basis of a signal inputted from the overall control unit 140. The timing generator 301 transmits a signal for setting the output mode of the CCD 121, a timing pulse which determines the start and end of exposure of the CCD 121 and the like. The timing pulse is also inputted to other processing units, thereby achieving synchronization between the output of the image data from the CCD 121 and various processes on the image data.

Referring again to FIG. 14, a signal processing circuit 302 performs a predetermined analog signal process on image data outputted from the CCD 121. The signal processing circuit 302 has therein a CDS (correlated double sampling) circuit and an AGC (auto gain control) circuit, reduces noise in image data by the CDS circuit and adjusts the level of image data by the AGC circuit.

An A/D converter 303 converts image data of an analog signal outputted from the signal processing circuit 302 to a digital signal. An image processing unit 304 performs various image processes on the image data converted to the digital signal. Concretely, the image processing unit 304 performs: a color component interpolating process for interpolating a color component so that each pixel has data of all of R, G and B; a white balance correction for correcting an influence of an illumination light source on the subject; a γ correction for correcting a tone characteristic of an image, a contrast correction for correcting contrast, and the like.

An image memory 305 is a memory for temporarily storing image data outputted from the image processing unit 304 and has a storage capacity capable of storing at least one frame of the normal image D2.

A display image generating unit 310 reads out the image data stored in the image memory 305 and generates screen image data (live-view image or the like) to be displayed on the display screen of the liquid crystal monitor 28. Since the resolution of the liquid crystal monitor 28 of the third preferred embodiment is 320 horizontal pixels×240 vertical pixels, the display image generating unit 310 generates display image data having the same resolution.

A VRAM 311 is a buffer memory for storing the screen image data generated by the display image generating unit 310. The display image data stored in the VRAM 311 is read in accordance with the refresh rate of the liquid crystal monitor 28 and displayed on the liquid crystal monitor 28. The refresh rate of the liquid crystal monitor 28 of the preferred embodiment is 30 fps, and the display image data stored in the VRAM 311 is displayed on the liquid crystal monitor 28 every 1/30 second.

Image data outputted from the A/D converter 303 in the image capturing standby state is also inputted to an AF computing unit 307 and a luminance computing unit 308 and is used for exposure control and focus control.

The AF computing unit 307 derives a focus evaluation value used for the focus control from the input image data. Concretely, the contrast value is obtained from pixels in the focus area in the image data and is used as a focus evaluation value. The obtained focus evaluation value is inputted to an overall control unit 140.

On the other hand, the luminance computing unit 308 derives a luminance value of a subject used for the exposure control from the input image data. Concretely, the luminance component value of each of pixels in the image data is computed and an average value of the luminance component values is determined as the luminance value of the subject. The computed luminance value of the subject is inputted to the overall control unit 140.

A lens driving unit 309 drives the focusing lens 31 in the taking lens 3, the aperture in the taking lens 3 which determines an incident light amount and the like. The lens driving unit 309 is electrically connected to the overall control unit 140 and, drives the focusing lens 31 in the taking lens 3 and the like on the basis of a signal inputted from the overall control unit 140.

A card I/F 306 records image data to the memory card 9 inserted into the card slot 26 and reads image data from the memory card 9. The card I/F 306 is also electrically connected to the overall control unit 140 and records/reads image data on the basis of a signal from the overall control unit 140.

An operation input unit 120 is an operating member shown as one functional block including the shutter release button 25, main switch 24, mode switching lever 27, button group 29 and the like. The operation of the operation input unit 120 is inputted as a signal to the overall control unit 140.

The overall control unit 140 controls the operations of the various members of the digital camera 1 in a centralized manner and includes a CPU 141 for performing various computing processes, a RAM 142 as a work area for computation, and a ROM 143 in which a control program or the like is stored.

The various functions of the overall control unit 140 are realized when the CPU 141 performs a computing process in accordance with a control program stored in the ROM 143. Such a control program is usually prestored in the ROM 143. Alternately, a new control program can be, for example, read from the memory card 9 to be stored into the ROM 143. In FIG. 14, an exposure control unit 151, a display control unit 152 and an AF control unit 153 are shown schematically as functional blocks as a part of functions realized when the CPU 141 performs computing operations in accordance with a control program.

The exposure control unit 151 performs an exposure control. Concretely, the exposure control unit 151 determines a shutter speed (corresponding to charge accumulation time of the CCD 121) and an aperture value (corresponding to the diameter of the opening of the aperture) on the basis of a luminance value of the subject inputted from the luminance computing unit 308 and a predetermined program chart. The exposure control unit 151 transmits signals to the timing generator 301 and the lens driving unit 309 so as to achieve the determined shutter speed and aperture value. When the subject has low luminance and exposure becomes insufficient, the signal processing circuit 302 is caused to adjust the level of image data outputted from the CCD 121 so as to correct improper exposure.

The display control unit 152 performs controls display of the liquid crystal monitor 28. The screen image data stored in the VRAM 311 is read in accordance with the refresh rate of the liquid crystal monitor 28 by the display control unit 152 and converted into a video signal. The video signal is displayed on the liquid crystal monitor 28. The display control unit 152 controls a generating method used when the display image generating unit 310 generates screen image data and the like.

The AF control unit 153 monitors the focus evaluation value inputted from the AF computing unit 307 and performs the auto-focus control for driving the focusing lens 31 in the taking lens 3 so that focus is achieved on a subject image in the focusing area in image data. The AF control unit 153 controls the driving of the focusing lens 31 by transmitting a predetermined signal to the lens driving unit 309. The method of moving the focusing lens 31 to the focus position by the AF control unit 153 is similar to that in the first preferred embodiment.

3-2. Outline of Operation of Digital Camera

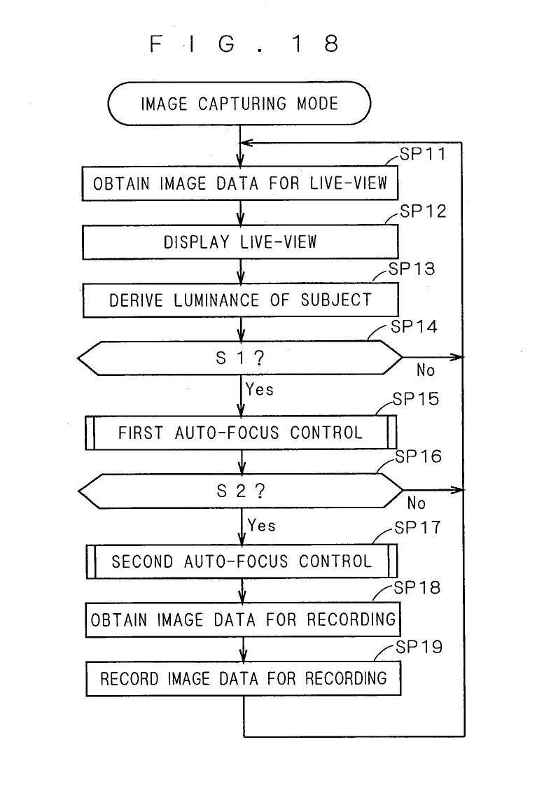

An outline of the operation in the image capturing mode of the digital camera 1 will now be described. FIG. 18 is a diagram showing the outline of the operation in the image capturing mode of the digital camera 1.

When set in the image capturing mode, the digital camera 1 enters an image capturing standby state and performs live-view display of image data repeatedly obtained by the CCD 121 onto the liquid crystal monitor 28.

Specifically, first, image data for live-view display is obtained by the CCD 121 (step SP11). At this time, the output mode of the CCD 121 is set to the “first compression mode” by the timing generator 301, and the first compressed image D3 is outputted from the CCD 121. The output first compressed image D3 is subjected to predetermined processes in the signal processing circuit 302, A/D converter 303 and image processing unit 304, and the processed image is stored into the image memory 305. A live-view image is generated from the first compressed image D3 by the display image generating unit 310. The generated live-view image is displayed on the liquid crystal monitor 28. In such a manner, the live-view display of a subject image on the liquid crystal monitor 28 is performed (step SP12).

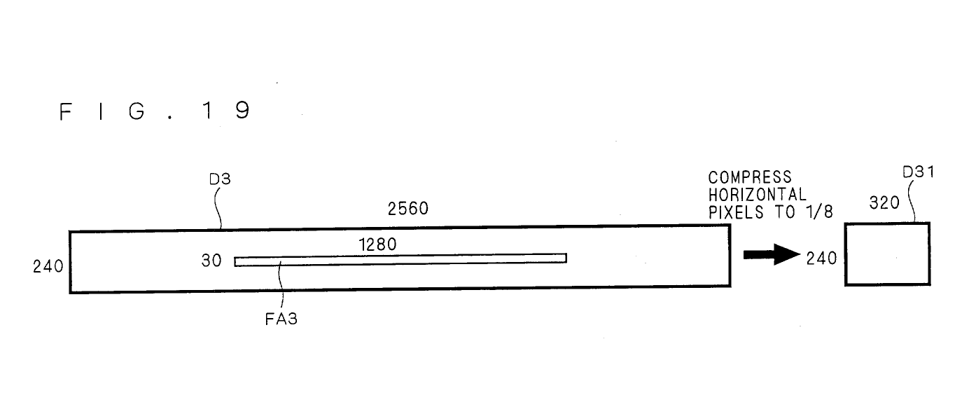

FIG. 19 is a diagram for describing a method of generating a live-view image from the first compressed image D3. As described above, the first compressed image D3 has 2560 horizontal pixels×240 vertical pixels. By simply reducing pixels in the horizontal direction to ⅛, a live-view image D31 having 320 horizontal pixels×240 vertical pixels which coincides with the resolution of the liquid crystal monitor 28 is generated.

While performing such a live-view display, the first compressed image D3 is also inputted to the luminance computing unit 308 where a luminance value of a subject is derived. The derived luminance value of the subject is inputted to the overall control unit 140. On the basis of the luminance value, the shutter speed and the aperture value are determined by the exposure control unit 151 (step SP13).

The series of operations in steps SP11 to SP13 is repeated until the shutter release button 25 is half-pressed (so far as “No” is indicated in step SP14). When the output mode of the CCD 121 is the “first compression mode”, the frame rate is 30 fps. Consequently, the series of operations is repeated at the intervals of 1/30 second. In the digital camera 1 of the third preferred embodiment, the auto-focus control is not executed during the series of operations. In the following description, therefore, the operations in steps SP11 to SP13 will be called an “individual live-view operation”.

In the individual live-view operation, when the shutter release button 25 is half-pressed (S1) (“Yes” in step SP14), it is accepted as an instruction of starting the focus control. In response to this, a first auto-focus control is performed by the AF control unit 153 (step SP15).

Further, when the shutter release button 25 is full-pressed (S2) (“Yes” in step SP16), it is accepted as an instruction of obtaining image data for recording. In response to this, the image data for recording is obtained. Prior to this, a second auto-focus control is performed by the AF control unit 153 (step SP17). The second auto-focus control is performed as a continuous control when the lens position could not be driven to the focus position in the first auto-focus control or as adjustment of the final lens position.

After the second auto-focus control is finished, exposure is made by the CCD 121 at a set shutter speed and the image data for recording is obtained (step SP18). At this time, the output mode of the CCD 121 is set to the “normal mode” by the timing generator 301, and the normal image D2 is outputted from the CCD 121. The output normal image D2 is subjected to predetermined processes in the signal processing circuit 302, A/D converter 303 and image processing unit 304, and the processed image is stored in the image memory 305. After that, the stored image is compressed by a compression method conformed with the JPEG or the like, and the compressed image is recorded in the memory card 9 (step SP19).

After recording the image data for recording, or in the case the shutter release button 25 is half-pressed but is not fuill-pressed (so far as “No” is indicated in step SP16), the flow returns again to step SP11 and the individual live-view operation is performed.

3-3. Auto-Focus Control

In the digital camera 1, a subject image is displayed on the liquid crystal monitor 28 (live-view display) also during the auto-focus control. The operation at the time of the auto-focus control will be described in detail below. In the third preferred embodiment, the first and second auto-focus controls (steps SP15 and SP17) are performed in the same manner.

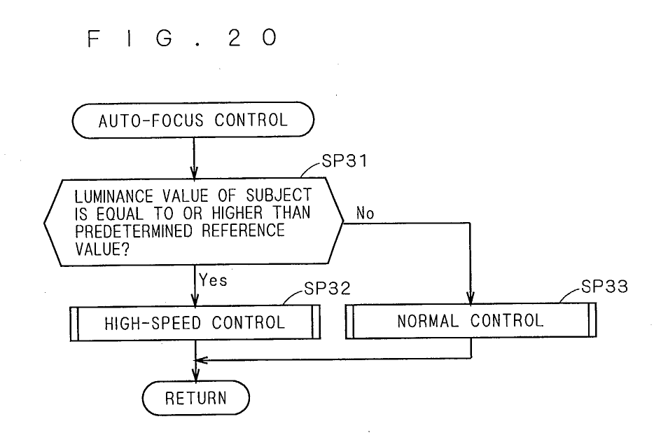

In the digital camera 1, the method of the auto-focus control varies according to the luminance of a subject. Consequently, as shown in FIG. 20, at the time of performing the auto-focus control, whether the luminance value of the subject inputted from the luminance computing unit 308 is equal to or higher than a predetermined reference value is determined by the AF control unit 153 (step SP31). If the luminance value of the subject is equal to or higher than the predetermined reference value, a high-speed control is carried out (step SP32). If the luminance value of the subject is lower than the predetermined reference value, a normal control (step SP32) is carried out.

When the luminance value of the subject is relatively low, a shutter speed of relatively long time is necessary. The shutter speed depends on an output interval of image data of the CCD 121. In the high-speed control (step SP33), the output mode of the CCD 121 is set to the “second compression mode” of outputting image data at the intervals of 1/60 second (the details will be described later). Consequently, the output interval of image data is relatively short and exposure is insufficient. There is the possibility that a valid focus evaluation value cannot be obtained. If the level of image data is adjusted by the signal processing circuit 302 or the like in order to solve the problem, noise in the image data increases and the precision of an evaluation value deteriorates as a result. Consequently, by performing the high-speed control only in the case where the luminance value of the subject is equal to or higher than the predetermined reference value, a high-precision auto-focus control can be carried out.

3-3-1. Normal Control

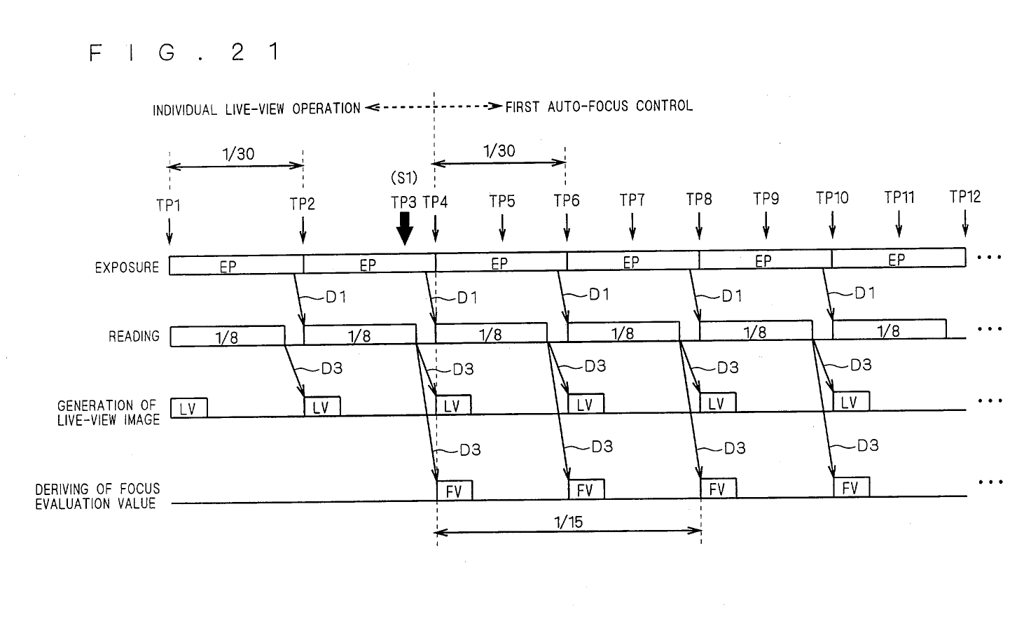

First, the normal control (step SP33) will be described. FIG. 21 is a timing chart showing the auto-focus control operation in the normal control. In FIG. 21, each of reference characters and numerals TP1 to TP12 indicates a time point. The time point TP3 is a time point when the shutter release button 25 is half-pressed (S1) in the individual live-view operation. From the start time point TP4 of exposure EP immediately after that, the first auto-focus control is performed.

As described above, in the individual live-view operation (from the time point TP1 to the time point TP4), the output mode of the CCD 121 is set to the “first compression mode”, the exposure EP is repeated at the intervals of 1/30 second, and the first compressed image D3 is outputted by reading the obtained image data D1 while compressing the obtained image data D1 to ⅛ by skipping. At the same intervals of 1/30 second, generation LV of a live-view image from the first compressed image D3 is performed by the method shown in FIG. 19. By the above operations, the subject image displayed on the liquid crystal monitor 28 is updated every 1/30 second.

When the shutter release button 25 is half-pressed (at the time point TP3), the operation advances to the auto-focus control (time point TP4). In the normal control, the output mode of the CCD 121 remains as the “first compression mode”. Also after shift to the auto-focus control (time points TP4 to TP12, . . . ), the exposure EP and reading of image data are repeated at the intervals of 1/30 second. The generation LV of the live-view image and a process similar to the individual live-view operation are also repeated at the intervals of 1/30 second. Consequently, also at the time of auto-focus control, a subject image displayed on the liquid crystal monitor 28 is updated every 1/30 second, and the live-view display is performed.

After shifting to the auto-focus control (time points TP4 to TP12, . . . ), the deriving FV of the focus evaluation value is performed in the AF computing unit 307, on the basis of a focus area FA3 (1280 horizontal pixels×30 vertical pixels, see FIG. 19) in the first compressed image D3 which is outputted. Then, on the basis of the focus evaluation value, the focusing lens 31 is driven. Since the first compressed image D3 is outputted at the intervals of 1/30 second, the deriving FV of the focus evaluation value is performed also at the intervals of 1/30 second. Such operations are repeated and the focusing lens 31 is finally moved to the focus position.

3-3-2. High-Speed Control

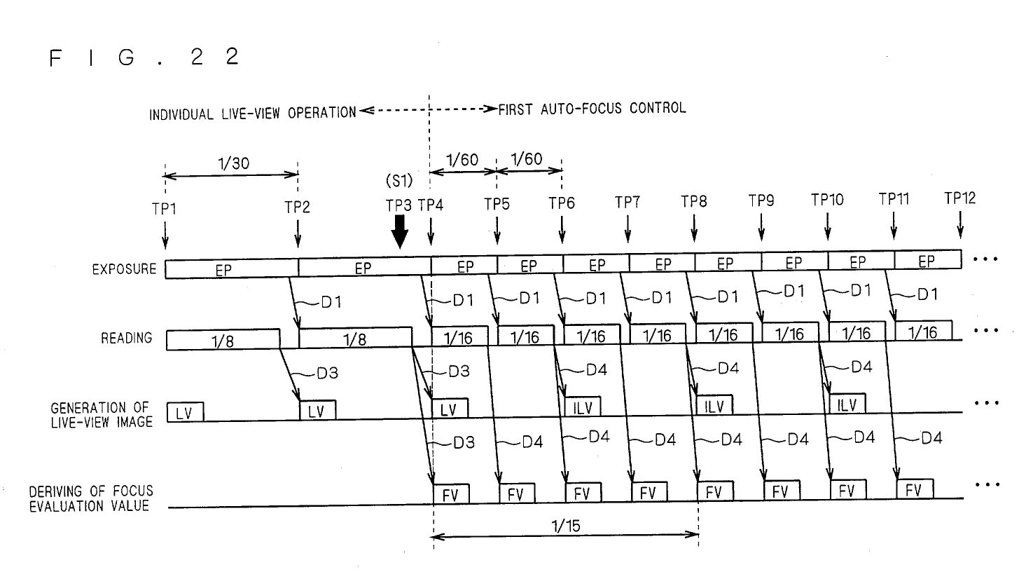

The high-speed control (step SP32) will now be described. FIG. 22 is a time chart showing the auto-focus control operation in the high-speed control. In a manner similar to FIG. 21, also in FIG. 22, the shutter release button 25 is half-pressed at the time point TP3 and the auto-focus control is performed from the time point TP4. The individual live-view operation (time points TP1 to TP4) is similar to the normal control.

When the shutter release button 25 is half-pressed (time point TP3), the operation shifts to the auto-focus control (time point TP4). A that time, under the high-speed control, the output mode of the CCD 121 is changed to the “second compression mode” by the timing generator 301. Therefore, after the shift to the auto-focus control (time points TP4 to TP12, . . . ), the obtained image data D1 is read while being compressed to 1/16 by skipping, and the exposure EP is repeated at the intervals of 1/60 second. That is, the second compressed image D4 is repeatedly outputted from the CCD 121 at the intervals of 1/60 second.

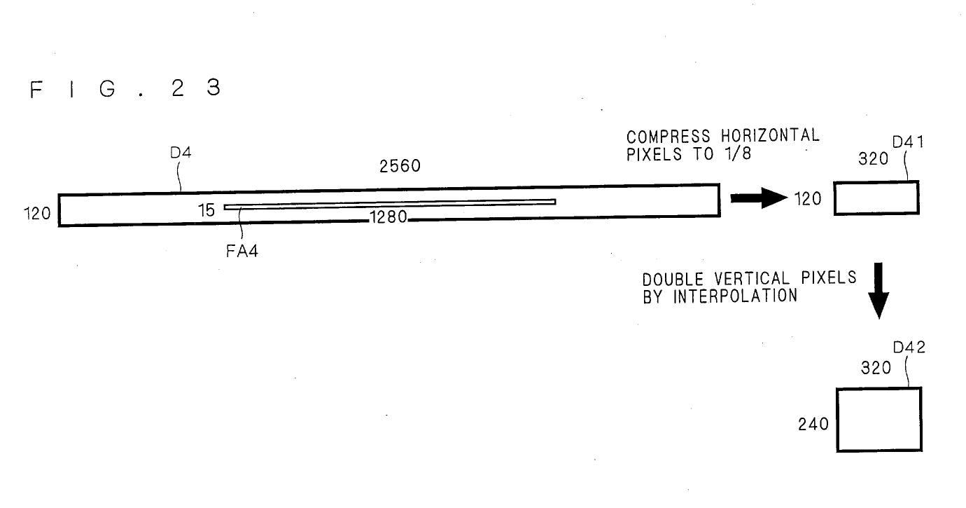

From the time point TP6 on, generation IVL of a live-view image from the second compressed image D4 is performed by the display image generating unit 310. FIG. 23 is a diagram for describing a method of generating a live-view image from the second compressed image D4. As described above, the second compressed image D4 has 2560 horizontal pixels×120 vertical pixels. If the pixels in the horizontal direction are simply compressed to ⅛ by skipping, image data D41 of 320 horizontal pixels×120 vertical pixels is generated, and image data having resolution (320 horizontal pixels×240 vertical pixels) necessary for display on the liquid crystal monitor 28 cannot be obtained. That is, that the first compressed image D1 is image data having a data amount sufficient to display a subject image whereas the second compressed image D4 is image data of which data amount is not sufficient to display a subject image.

Consequently, the display image generating unit 310 doubles the pixels in the vertical direction of the image data D41 by interpolation, thereby generating a live-view image D42 having 320 horizontal pixels×240 vertical pixels. As a pixel interpolating method, for example, any of the bilinear method of obtaining the value of a new pixel from a plurality of surrounding pixels by linear interpolation, the nearest neighbor method, the bicubic method, and the like can be employed. Although the picture quality of the live-view image D42 generated from the second compressed image D4 is lower than that of the live-view image D31 (see FIG. 19) generated from the first compressed image D3, the picture quality is sufficient in practice to grasp the state of the subject image.

Referring again to FIG. 22, the generation ILV of the live-view image by interpolation from the second compressed image D4 (hereinafter, referred to as “interpolation generation”) is performed at the intervals of 1/30 second in accordance with the refresh rate of the liquid crystal monitor 28. In other words, the interpolation generation ILV of a live-view image is performed, at a ratio of once every twice of the exposure EP (and reading). Therefore, also at the time of the auto-focus control of the high-speed control, a subject image displayed on the liquid crystal monitor 28 is updated every 1/30 second, and a live-view display is smoothly carried out.

Alternately, the interpolation generation ILV of a live-view image may be performed every 1/60 second in accordance with the output intervals of the second compressed image D4. Particularly, in an image capturing apparatus having a liquid crystal monitor in which the refresh rate is changeable, by further changing the refresh rate of the liquid crystal monitor to 60 fps, the live-view display is performed more smoothly, and a change in the subject image can be easily grasped.

The focus evaluation value is derived by the AF computing unit 307 on the basis of the focus area FA4 (1280 horizontal pixels×15 vertical pixels, see FIG. 23) in the output second compressed image D4. Since the second compressed image D4 is outputted at intervals of 1/60 second, the deriving FV of the focus evaluation value is performed also at the intervals of 1/60 second. Therefore, the deriving FV of the focus evaluation value is made four times, for example, in a 1/15 second from the time point TP4 to the time point TP8. On the other hand, in the period from TP4 to TP8 in the normal control of FIG. 21, the deriving FV of the focus evaluation value is performed only twice. That is, by setting the output mode of the CCD 121 to the “second compression mode”, the number of deriving times FV of the focus evaluation value per unit time is doubled. It corresponds to an increase in the number of grasping a change in the evaluation value per unit time. Consequently, the driving speed of the focusing lens 31 can be increased without deteriorating precision of determining the lens position. Since a change in the evaluation value according to the lens position can be grasped precisely, the speed of determining the lens position can be also increased. Thus, the auto-focus control can be executed promptly with high precision.

As described above, in the digital camera 1, in order to perform the auto-focus control promptly, even in the case where the resolution of the obtained image data D1 is reduced to the resolution which is equal to or lower than the resolution necessary for display on the liquid crystal monitor 28, interpolation of skipped pixels can be performed by the display image generating unit 310. Consequently, a subject image can be appropriately displayed on the liquid crystal monitor 28.

In the digital camera 1, in response to acceptance of the instruction of starting the auto-focus control, the auto-focus control of the high-speed control is executed. That is, since high-speed control is executed in both of the first and second auto-focus controls, i.e., in the whole auto-focus control, the auto-focus control can be performed promptly.

4. Fourth Preferred Embodiment

A fourth preferred embodiment of the present invention will now be described. The CCD 121 in the digital camera 1 of the third preferred embodiment has, as an output mode capable of outputting image data at high speed, only the output mode in which the whole area of the obtained image data D1 is compressed by skipping. The CCD 121 of the digital camera 1 of the fourth preferred embodiment has an output mode of outputting only an area as a part of the obtained image data D1. Since the configuration of the digital camera 1 of the fourth preferred embodiment is similar to that of the third preferred embodiment, the points different from the third preferred embodiment will be mainly described below.

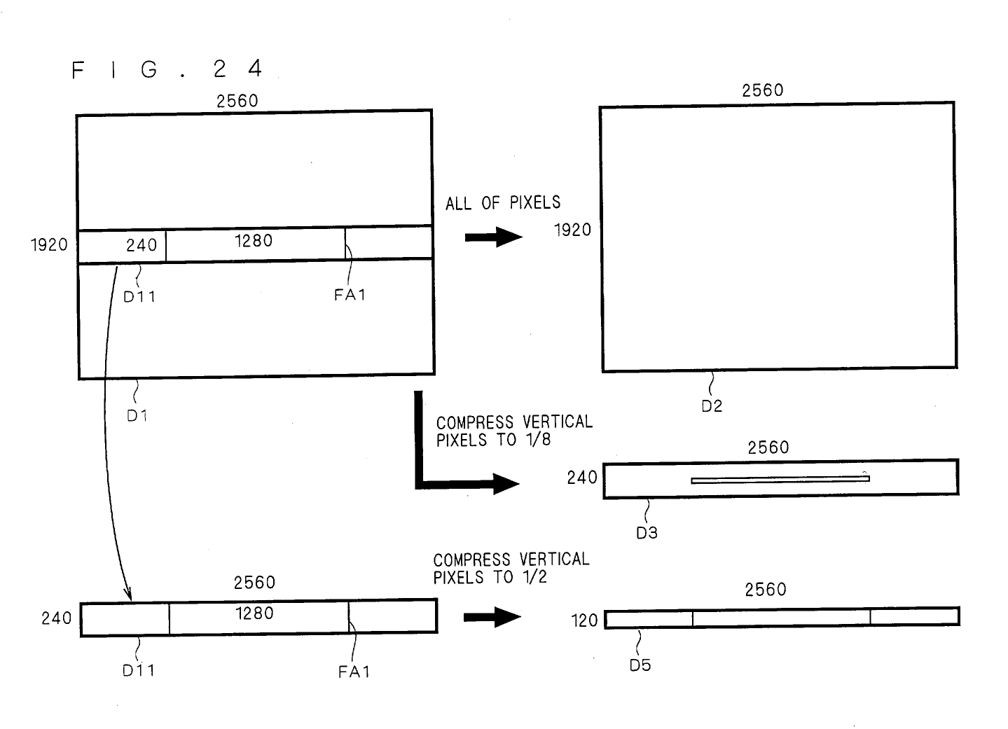

FIG. 24 is a diagram for describing image data outputted from the CCD 121 of the fourth preferred embodiment. The CCD 121 has, as output modes, the “normal mode” of outputting the normal image D2 and the “first compression mode” of outputting the first compressed image D3 similar to those in the third preferred embodiment and, in addition, an “area-limited mode” of outputting only a limited area including at least the focus area.

In a manner similar to the third preferred embodiment, the area FA1 of 1280 horizontal pixels×240 vertical pixels in the center portion in the obtained image data D1 is set as a focusing area. When the output mode of the CCD 121 is set to the “area-limited mode”, lines only in the limited area D11 having 2560 horizontal pixels×240 vertical pixels including the focus area FA1 are reduced by skipping lines so as to be read at the rate of ½. By the operation, an area-limited image D5 having 2560 horizontal pixels×120 vertical pixels obtained by compressing the pixels in the vertical direction of the limited area D11 to ½ by skipping is outputted.

Also in the “area-limited mode”, lines are read so that color components of pixels are arranged in accordance with the Bayer array pattern. Concretely, when it is assumed that the line L0 shown in FIG. 17 corresponds to the uppermost line of the area D11, lines indicated by the reference character C in the diagram, i.e., the 0-th line L0, the 3rd line L3, the 4th line L4, the 7th line L7 . . . are read. Since the number of lines to be outputted in the “area-limited mode” is 120, the frame rate becomes 60 fps (1/60 second interval), in a manner similar to the “second compression mode” in the third preferred embodiment. That is, in the “area-limited mode”, the amount of image data outputted per unit time can be doubled as compared with that in “first compression mode”.

Since the area-limited image D5 outputted in the “area-limited mode” is not an image indicative of the whole area of the obtained image data D1, it does not always include the whole subject image. That is, the area-limited image D5 is image data of which data amount is not sufficient to display the subject image.

The outline of the operation in the image capturing mode of the digital camera 1 of the fourth preferred embodiment is similar to that shown in FIG. 18. In the first auto-focus control (step SP15), the normal control (see FIG. 21) is always performed. Only at the time of the second auto-focus control (step SP17), the luminance value of the subject in FIG. 20 is determined. When the luminance value of the subject is equal to or higher than the predetermined reference value, the high-speed control is executed.

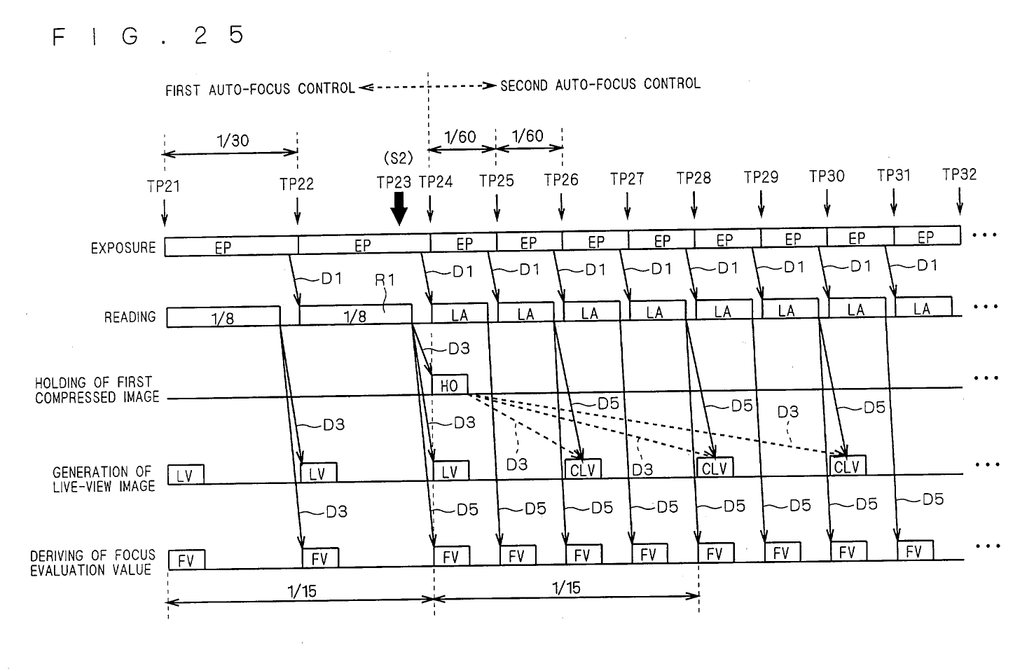

FIG. 25 is a time chart showing the auto-focus control operation in the high-speed control of the preferred embodiment. Reference characters and numerals TP21 to TP32 in FIG. 25 indicate time points. The time point TP23 is the time point when the shutter release button 25 is full-pressed (S2) in the first auto-focus control. From the time point TP24 of start of the exposure EP immediately after the time point TP23, the second auto-focus control is performed.

As described in the third preferred embodiment, in the first auto-focus control (from time point TP21 to time point TP24) as the normal control, the output mode of the CCD 121 is set to the “first compression mode”, so that the exposure EP and output of the first compressed image D3 obtained by compressing the image D3 to ⅛ by skipping are repeated at the intervals of 1/30 second. At the same intervals, the generation LV of a live-view image and the deriving FV of the focus evaluation value are carried out.

When the shutter release button 25 is full-pressed (time point TP23), the operation shifts to the second auto-focus control (time point TP24). At that time, under the high-speed control, the output mode of the CCD 121 is changed to the “area-limited mode” by the timing generator 301. Therefore, after the shift to the second auto-focus control (time points TP24 to TP32 . . . ), ½ compression reading in which a half of image data is read while skipping lines at the rate of ½ (hereinafter, also referred to as “limited reading”) LA of only the limited area D11 in the obtained image data D1 is performed, and the exposure EP is repeated at the intervals of 1/60 second. That is, the area-limited image D5 is repeatedly outputted from the CCD 121 at the intervals of 1/60 second.

On the other hand, at the time point TP24 when the operation shifts to the second auto-focus, the first compressed image D3 outputted by the latest ⅛ compression reading R1 is stored in the image memory 305 (reference symbol HO). After the time point TP26 on, generation CLV of a live-view image based on the stored first compressed image D3 and the area-limited image D5 periodically outputted is performed by the display image generating unit 310.

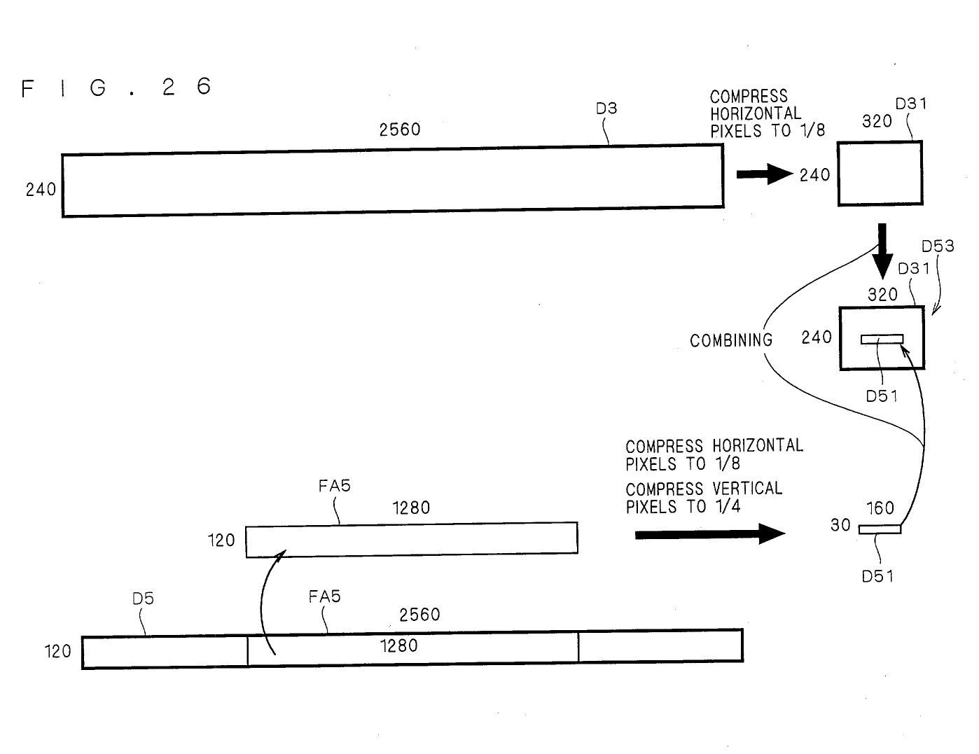

FIG. 26 is a diagram for describing a method of generating a live-view image on the basis of the first compressed image D3 and the area-limited image D5. First, the pixels in the horizontal direction of the first compressed image D3 held in the image memory 305 are compressed to ⅛ by skipping, thereby generating the image data D31 having 320 horizontal pixels×240 vertical pixels. On the other hand, the pixels in the horizontal direction only in the focus area FA5 (1280 horizontal pixels×120 vertical pixels) in the area-limited image D5 are compressed to ⅛ by skipping and the pixels in the vertical direction are compressed to ¼ by skipping, thereby generating the image data D51 having 160 horizontal pixels×30 vertical pixels. The image data D51 is buried as it is in an area corresponding to the focus area of the image data D31. In such a manner, the positions of the two pieces of image data D51 and D31 are aligned relative to each other and combined in a state where they are adjusted to have the same resolution (reduction ratio), thereby generating the live-view image D53.

Referring again to FIG. 25, the combining generation CLV of the live-view image by the combination based on the first compressed image D3 and the area-limited image D5 is performed at the intervals of 1/30 second in accordance with the refresh rate of the liquid crystal monitor 28. That is, the combining generation CLV of a live-view image is carried out at the ratio of once every twice of the exposure EP (and reading). Therefore, also at the time of the auto-focus control of the high-speed control of the preferred embodiment, the subject image displayed on the liquid crystal monitor 28 is updated every 1/30 second.

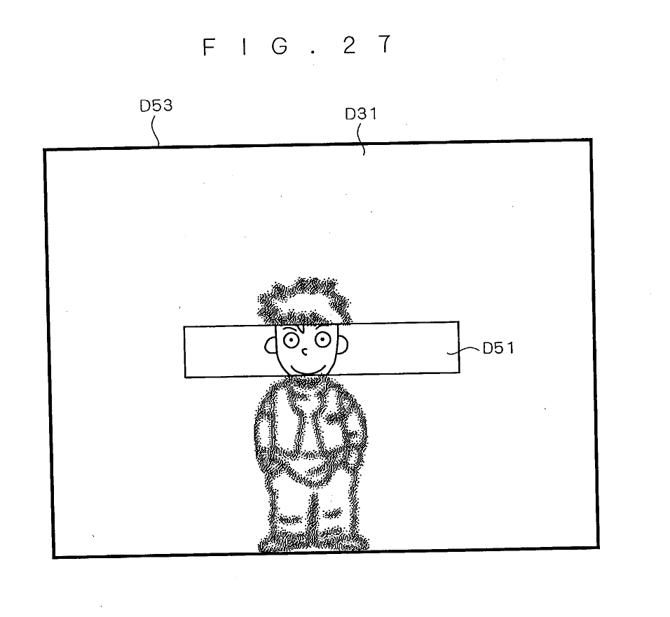

In the live-view image D53, the focus area is constructed by the pixels of the area-limited image D5 and the peripheral area of the focus area is constructed by the pixels of the first compressed image D3. The area-limited image D5 is formed of image sequentially newly obtained whereas the first compressed image D3 is formed of image stored in the image memory 305. Consequently, the peripheral area is not updated in the live-view image D53 and only the focus area is sequentially updated. Therefore, as shown in FIG. 27, focus is achieved on only the subject image in the focus area and the degree of focus can be clearly grasped.

The focus evaluation value is derived by the AF computing unit 307 on the basis of the focus area FA5 (see FIG. 26) in the area-limited image D5. Since the area-limited image D5 is outputted at the intervals of 1/60 second, the deriving FV of the focus evaluation value is also performed at the intervals of 1/60. Therefore, the deriving FV of the focus evaluation value is performed, for example, four times in a 1/15 second from the time point TP24 to the time point TP26. On the other hand, in a 1/15 second from the time point TP21 to TP24 in the normal control, the evaluation value is derived only twice. Therefore, also in the high-speed control of the preferred embodiment, the number of deriving FV times of the focus evaluation value per unit time is twice as many as that in the normal control. Thus, the auto-focus control can be carried out promptly with high precision.

As described above, in the fourth preferred embodiment, since the area-limited image D5 as an area including at least the focus area is outputted, the auto-focus control can be carried out promptly. On the other hand, the live-view image is generated by combining the first compressed image D3 including a whole subject image and the area-limited image D5, so that the subject image can be appropriately displayed on the liquid crystal monitor 28.

As compared with the third preferred embodiment, the focus area itself is compressed by skipping lines therein at a relatively low rate of ½, so that a high-precision focus value can be obtained. In addition, since pixel interpolation is not performed in a live-view image, an image of high resolution is obtained.

The focus area in the first compressed image D3 has horizontal 1280 pixels×30 vertical pixels and the focus area in the area-limited image D5 has 1280 horizontal pixels×120 vertical pixels. It is understood from the above that, even the rate of skipping is increased at the time of obtaining the area-limited image D5, the data amount necessary for the auto-focus control is assured. Therefore, the rate of skipping at the time of obtaining the area-limited image D5 may be increased. By the above, the frame rate can be further increased and the auto-focus control can be performed more promptly.

In the preferred embodiment, in response to acceptance of the instruction of obtaining image data for recording, the auto-focus control of the high-speed control is carried out. Therefore, after the instruction of obtaining image data for recording, image data for recording can be obtained promptly, so that the perfect moment for a good picture can be prevented from being missed.

5. Fifth Preferred Embodiment

A fifth preferred embodiment of the present invention will now be described. In the fourth preferred embodiment, the subject image in the peripheral area in the live-view image is not updated. In the fifth preferred embodiment, the subject image in the peripheral area is updated. The configuration of the digital camera 1 of the fifth preferred embodiment is similar to that of the third preferred embodiment. The CCD 121 has, as its output modes, the “normal mode”, the “first compression mode”, and the “area-limited mode” in a manner similar to the CCD of the fourth preferred embodiment. The outline of the operation in the image capturing mode is similar to that shown in FIG. 18. In a manner similar to the fourth preferred embodiment, the normal control is executed in the first auto-focus control (step SP15). In the second auto-focus control (step SP17), when the luminance value of the subject is equal to or higher than the predetermined reference value, a high-speed control is carried out.

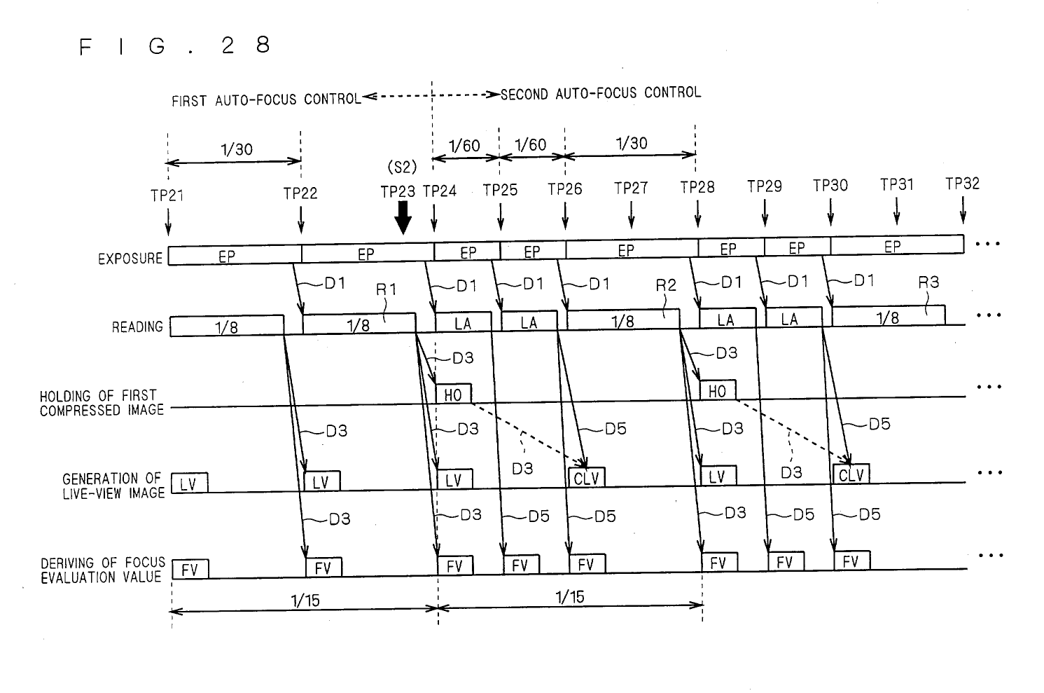

FIG. 28 is a time chart showing the auto-focus control operation in the high-speed control of the fifth preferred embodiment. In a manner similar to FIG. 25, also in FIG. 28, the shutter release button 25 is full-pressed at the time point TP23 and the second auto-focus control is executed from the time point TP24.

When the shutter release button 25 is full-pressed (time point TP23), the operation shifts to the second auto-focus control (time point TP24). At that time, under the high-speed control, the output mode of the CCD 121 is changed to the “area-limited mode” by the timing generator 301.

In such a manner, the limited reading LA of only the limited area D11 in the obtained image data D1 is performed. When the limited reading LA of the obtained image data D1 is performed twice (from time point TP24 to time point TP26), the output mode of the CCD 121 is set to the “first compression mode”, and the obtained image data D1 is read while being compressed to ⅛ by skipping (from time point TP26 to time point TP28). After that, the output mode of the CCD 121 is switched between the “area-limited mode” and the “first compression mode” at the same intervals. That is, the output mode of the CCD 121 is switched at the intervals of 1/30 second, the area-limited image D5 is outputted at the rate of twice every three times of reading, and the first compressed image D3 is outputted at the rate of once every three times of reading. Also in the exposure EP of the CCD 121, an operation in which exposure at the intervals of 1/60 second is performed twice and exposure at the interval of 1/30 second is performed once, is periodically repeated.

On the other hand, at the time point when the first compressed image is outputted from the CCD 121 (the time point TP24 at which the operation shifts to the second auto-focus, the time point T28 at which the mode is changed from the “first compression mode” to the “area-limited mode”, . . . ), the first compressed image D3 outputted by the latest ⅛ compression reading (R1, R2, R3, . . . ) is stored into the image memory 305 (reference symbol HO). That is, the first compressed image D3 stored in the image memory 305 is updated each time the first compressed image D3 is outputted in the “first compression mode”.

A live-view image is generated at the intervals of 1/30 second (time points TP24, TP26, TP28, TP30, . . . ) on the basis of the first compressed image D3 and the area-limited image D5. The generating method varies according to image data which is outputted most recently. Specifically, when image data which is outputted most recently is the first compressed image D3 (time points TP24, TP28, . . . ), the generation LV of the live-view image shown in FIG. 19 is performed. On the other hand, when image data which is outputted most recently is the area-limited image D5 (time points TP26, TP30, . . . ), the combining generation CLV of a live-view image shown in FIG. 26 is performed. As described above, since the first compressed image D3 in the image memory 305 is sequentially updated, even in the case of generating the display image data by the method shown in FIG. 26, the peripheral area of the display image data is updated. Therefore, in the embodiment, the whole area of the display image data can be updated.

When image data which is outputted most recently is the first compressed image D3 (time points TP24, TP25, TP28, TP29, . . . ), the focus evaluation value is derived on the basis of the focus area FA3 (see FIG. 19) in the first compressed image D3. When image data which is outputted most recently is the area-limited image D5 (time points TP26, TP30, . . . ), the focus evaluation value is derived on the basis of the focus area FA5 (see FIG. 26) in the area-limited image D5. In a 1/15 second from time point TP24 to time point TP28, image data is outputted from the CCD 121 three times, so that the deriving FV of the focus evaluation value is also performed three times. After that, the deriving FV of the evaluation value of three times at the interval of 1/15 second is repeated. On the other hand, in the 1/15 second from the time point TP21 to the time point TP24 in the normal control, the evaluation value is derived only twice. Therefore, in the high-speed control of the preferred embodiment, the number of deriving FV times of the focus evaluation value per unit time is 1.5 times as many as that in the normal control. The auto-focus control can be performed promptly with high precision.

As described above, in the preferred embodiment, the output mode is switched between the “first compression mode” and the “area-limited mode”, so that a high-speed focus control can be performed while updating the whole area of the live-view image.

6. Modifications

In the first and second preferred embodiments, as image data used for live-view display, the normal image 61 of all of the pixels of the CCD 21 is used. It is also possible to use image data obtained by skipping pixels at predetermined intervals at the time point of outputted from the CCD 21. As the image data obtained by skipping lines at predetermined intervals includes a whole subject image, the image data can be used for live-view display. By using such image data, the operation of the auto-focus control can be performed more promptly.

In the first and second preferred embodiments, when the output mode of the CCD 21 is set as the area-limited mode, the state of the display screen of the liquid crystal monitor 28 on which a subject image is displayed is held, by holding a live-view image in the VRAM 210. It is also possible to hold the state of the display screen of the liquid crystal monitor 28 by, for example, not rewriting (refreshing) the display screen of the liquid crystal monitor 28.

Although the high speed control is performed in both of the first and second auto-focus controls in the third preferred embodiment, in a manner similar to the fourth and fifth preferred embodiments, the high speed control may be performed only in the second auto-focus control. To the contrary, although the high speed control is performed only in the second auto-focus control in the fourth and fifth preferred embodiments, the high speed control may be performed in both of the first and second auto-focus controls.

As described above, by performing the high speed control in both of the first and second auto-focus controls, the high speed control is performed in the whole auto-focus control, so that the auto-focus control can be carried out at high speed. In the case of considering operability, however, the possibility that framing is performed in the first auto-focus is strong, it is preferable to place importance on display of a subject image. On the other hand, in the second auto-focus control, since the control is performed after the instruction of obtaining image data for recording, it is preferable to place importance on high speed of the auto-focus control. Consequently, by performing high-speed control only in the second auto-focus control, operability can be improved.

The method of high-speed control in the third to fifth preferred embodiments may be switched in accordance with an operation stage. For example, the method of high-speed control of the third preferred embodiment is used in the first auto-focus control, and the method of high-speed control of the fourth preferred embodiment is used in the second auto-focus control. Since the whole subject image can be updated by the method of high-speed control of the third preferred embodiment, as compared with the high-speed control of the fourth preferred embodiment, the method of high-speed control of the third preferred embodiment is a control method placing higher importance on display of a subject image. On the other hand, since the frame rate can be further increased by the method of high-speed control of the fourth preferred embodiment, as compared with the high-speed control of the third preferred embodiment, the method of high-speed control of the fourth preferred embodiment is a method placing higher importance on higher speed of the auto-focus control. Therefore, in the above manner, importance can be placed on the display of a subject image or high speed of the auto-focus control, as necessary at operation stages. Thus, operability can be improved.

The method of generating a live-view image is not limited to the method in the preferred embodiments but a live-view image may be generated by other methods. For example, the second compressed image D4 in the third preferred embodiment is an image of which number of pixels in the vertical direction is ½ of resolution necessary for display on the liquid crystal monitor 28. Consequently, a live-view image may be generated by combining two second compressed images D4 obtained continuously. Concretely, by inserting data in horizontal pixel lines of one of the two second compressed images D4 into the data in the horizontal pixel lines of the other of the two second compressed images D4, the two second compressed images D4 are combined so that the horizontal pixel lines of both of the images are arranged alternately. Since the second compressed image D4 is obtained at the intervals of 1/60 second by such a method as well, the live-view image can be generated at the intervals of 1/30 second. Accordingly, a live-view image can be generated without performing interpolation, and an image of high resolution can be obtained. In such a case, in order to improve the picture quality of a live-view image, it is preferable to make a read start line at the time of outputting the second compressed image D4 from the CCD 121 vary between the two second compressed images D4 to be combined.

In each of the foregoing preferred embodiments, when the output mode of the CCD is the “area-limited mode”, the area-limited image to be outputted is image data of an area constructed by horizontal pixel lines including a focus area. However, the area-limited image is required to include at least the focus area. For example, image data of only the focus area may be used as an area-limited image.

In each of the foregoing preferred embodiments, the luminance value of a subject is obtained from image data which is outputted from the CCD. It is also possible to detect the luminance value of the subject by using a luminance sensor or the like.

Although it has been described in each of the foregoing preferred embodiments that the various functions are realized when the CPU performs computing processes in accordance with a program, all or a part of the functions may be realized by a dedicated electric circuit. Particularly, by constructing the part of repeating an arithmetic operation by a logic circuit, high-speed computation is realized. All or a part of functions realized by an electric circuit may be realized when the CPU performs a computing process in accordance with a program.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image capturing part for obtaining an image of a subject via an optical system, said image capturing part having a first output mode of outputting first image data expressing a whole area of said image and a second output mode of outputting second image data including at least a focusing area of said image at higher speed as compared with said first output mode;
a focus controller for performing a focus control of said optical system by referring to said focusing area;
a display for displaying said image of said subject on a display screen on the basis of said first image data;
an image capturing controller for enabling said second output mode in performing said focus control; and
a display controller for holding a state of said image of said subject on said display screen in said second output mode.

2. The image capturing apparatus according to claim 1, wherein
said image capturing controller alternately enables said first output mode and said second output mode at predetermined intervals in performing said focus control.

3. The image capturing apparatus according to claim 2, further comprising:
an acceptor for accepting an instruction of starting said focus control, wherein
said image capturing controller alternately enables said first and second output modes at said predetermined intervals in response to said instruction of starting said focus control.

4. The image capturing apparatus according to claim 2, further comprising:
a determining part for determining whether said optical system is in the vicinity of a focus position or not, wherein
when the lens position is in the vicinity of the in-focus state of said optical system, said image capturing controller alternately enables said first and second output modes at said predetermined intervals.

5. The image capturing apparatus according to claim 2, further comprising:
a display switch for switching said display between a display state and an undisplay state, wherein
said image capturing controller alternately enables said first and second output modes at said predetermined intervals in said display state, and
said image capturing controller enables said second output mode in said undisplay state.

6. The image capturing apparatus according to claim 2, further comprising:
a detector for detecting luminance of said subject, wherein
said image capturing controller alternately enables said first output mode and said second output mode at said predetermined intervals only when said luminance is higher than a predetermined reference value.

7. The image capturing apparatus according to claim 2, wherein
said image capturing part outputs said first image data at output intervals of a first period in said first output mode,
said image capturing part outputs said second image data at output intervals of a second period in said second output mode,
said image capturing controller alternately enables said first and second output modes at said output intervals of said first period, and
said first period and said second period satisfy the following relation:
T1=n·T2,
where “T1” is said first period; “T2” is said second period; and “n” is an integer larger than one.

8. An image capturing apparatus comprising:
an image capturing part for obtaining an image of a subject via an optical system;
a focus controller for performing a focus control of said optical system; and
an image display, wherein
said image capturing part has a first output mode of outputting first image data which is sufficient for both performing said focus control and displaying said image of said subject, and
a second output mode of outputting second image data which is sufficient for performing said focus control but is insufficient for displaying said image of said subject,
said image capturing apparatus further comprises a screen image generator for generating a screen image of said subject on the basis of the second image data, and
said screen image is displayed on said image display in said second output mode.

9. The image capturing apparatus according to claim 8, wherein
said image capturing part includes:
an image signal obtaining part for obtaining an image signal constructed of a two-dimensional array of a plurality of pixels; and
a skipper for skipping some of said plurality of pixels in one of directions of said two-dimensional array in said second output mode to obtain said second image data including remaining pixels, and
said screen image generator interpolates between said remaining pixels in said second image data to thereby obtain said screen image.

10. The image capturing apparatus according to claim 8, further comprising:
a storage for storing said first image data obtained by said image capturing part in said first output mode, wherein
said image capturing part gives at least a part of a focusing area in an image signal of said subject to said second image data in said second output mode, and
said screen image generator obtains said screen image on the basis of said first image data and said second image data.

11. The image capturing apparatus according to claim 9, further comprising:
an acceptor for accepting an instruction of starting said focus control, wherein
said image capturing controller enables said second output mode in response to said instruction of starting said focus control.

12. The image capturing apparatus according to claim 9, further comprising:
an acceptor for accepting an instruction of causing said image capturing part to obtain an image for recording, wherein
said image capturing controller enables said second output mode in response to said instruction of obtaining said image for recording.

13. The image capturing apparatus according to claim 10, wherein
said image capturing part alternately enables said first output mode and said second output mode at predetermined intervals in said performing focus control, and
each time said first output mode is enabled, said first image data stored in said storage is updated.

14. The image capturing apparatus according to claim 11, further comprising:
a detector for detecting luminance of said subject, wherein
said image capturing part enables said second output mode only when said luminance is higher than a predetermined reference value.

15. An image capturing apparatus comprising:
an image capturing part for obtaining an image, said image capturing part having a first output mode of outputting first image data on the whole of an image capturing area and a second output mode of outputting second image data on part of said image capturing area;
a display controller for outputting image data to be used for displaying the whole of said image capturing area in said second output mode; and
a display for making a display on the basis of said image data outputted from said display controller.

16. The image capturing apparatus according to claim 15, further comprising:
a focus controller for performing a focus control of said image capturing part on the basis of image data outputted from said image capturing part; and
an image capturing controller for enabling said second output mode in performing said focus control.

17. The image capturing apparatus according to claim 16, wherein
said second image data has a sufficient amount of data for performing said focus control.

18. The image capturing apparatus according to claim 15, wherein
said display controller holds a state of a display screen of said display which displays the whole of said image capturing area on the basis of said first image data.

19. The image capturing apparatus according to claim 15, wherein
said display controller produces image data to be used for displaying the whole of said image capturing area on the basis of said second image data.

20. The image capturing apparatus according to claim 15, wherein
said second output mode causes said second image data to be outputted at higher speed as compared with said first output mode.
